(19) United States
(12) Patent Application Publication
(10) Pub. No.: US 2005/0264861 A1
(43) Pub. Date: Dec. 1, 2005

(54) Image display device and method of manufacturing the same

(76) Inventors: Takashi Enomoto, Fukaya-shi (JP); Masahiro Yokota, Fukaya-shi (JP); Akiyoshi Yamada, Fukaya-shi (JP); Hirotaka Unno, Fukaya-shi (JP); Takashi Nishimura, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/176,208

(22) Filed: Jul. 8, 2005

Related U.S. Application Data
(63) Continuation of application No. PCT/JP04/00111, filed on Jan. 9, 2004.

(30) Foreign Application Priority Data
Jan. 10, 2003 (JP) 2003-004409
Feb. 17, 2003 (JP) 2003-038722
Feb. 18, 2003 (JP) 2003-039422
Feb. 26, 2003 (JP) 2003-049053

(51) Int. Cl. G02B 26/08

(52) U.S. Cl. 359/224

(57) ABSTRACT

A vacuum envelope of a flat display device comprises a front substrate and a rear substrate opposed to each other and a rectangular frame body provided between respective peripheral portions of the front substrate and the rear substrate. The frame body has projections that protrude outward from individual corner portions. In manufacture, the projections are nipped and pulled outward, and the frame body is positioned with respect to the substrates and joined thereto with a longitudinal tension applied to each side of the frame body.

### CROSS REFERENCE TO RELATED APPLICATIONS

This is a Continuation Application of PCT Application No. PCT/JP2004/000111, filed Jan. 9, 2004, which was published under PCT Article 21(2) in Japanese.

This application is based upon and claims the benefit of priority from prior Japanese Patent Applications No. 2003-004409, filed Jan. 10, 2003; No. 2003-038722, filed Feb. 17, 2003; No. 2003-039422, filed Feb. 18, 2003; and No. 2003-049053, filed Feb. 26, 2003, the entire contents of all of which are incorporated herein by reference.

### BACKGROUND OF THE INVENTION

1. Field of the Invention

This invention relates to an image display device, having substrates opposed to each other, a frame body located between the substrates, and a plurality of pixels, and a method of manufacturing the image display device.

2. Description of the Related Art

In recent years, various flat display devices have been developed as a next generation of lightweight, thin display devices to replace cathode-ray tubes (CRT). These flat display devices include liquid crystal displays (LCDs), plasma display panels (PDPs), field emission displays (FEDs), surface-conduction electron emission displays (SEDs), etc. In an LCD, the intensity of light is controlled by utilizing the orientation of a liquid crystal. In a PDP, phosphors are caused to glow by ultraviolet rays that are produced by plasma discharge. In an FED, phosphors are caused to glow by electron beams from field-emission electron emitting elements. In an SED, phosphors are caused to glow by electron beams from surface-conduction electron emitting elements.

An FED described in Jpn. Pat. Appln. KOKAI Publication No. 2000-323074, for example, generally has a front substrate and a rear substrate that are opposed to each other across a predetermined gap. These substrates have their respective peripheral portions joined together by a frame body in the form of a rectangular frame, thereby constituting a vacuum envelope. A very high degree of vacuum is required of the envelope. In order to support an atmospheric load that acts on the rear substrate and the front substrate, a plurality of support members are arranged between these substrates. A phosphor screen is formed on the inner surface of the front substrate, and a large number of electron emitting elements for use as electron emission sources that excite the phosphors to luminescence are provided on the inner surface of the rear substrate.

The potential on the rear substrate side is substantially ground potential, and an anode voltage Va is applied to the fluorescent screen. Electron beams emitted from the electron emitting elements are applied to red, green, and blue phosphors that constitute the phosphor screen, whereby the phosphors are caused to glow and display an image.

According to the FED or SED of this type, the size of the electron emitting elements is on the order of micrometers, and the thickness of the display device can be reduced to several millimeters or thereabout. When compared with a CRT that is used as a display of an existing TV or computer, therefore, it can be made lighter in weight and thinner, and moreover, power-saving.

In the FED described above, the inside of the envelope must be kept under high vacuum. Also in the PDP, the envelope must be filled with discharge gas after it is evacuated once. Proposed in Jpn. Pat. Appln. KOKAI Publication No. 2000-229825 is a method in which a front substrate and a rear substrate that constitute an envelope are finally assembled in a vacuum tank, as means for evacuating the envelope.

In this method, the front substrate and the rear substrate that are first located in the vacuum tank are fully heated in advance. This is done in order to reduce gas discharge from the inner wall of the envelope that is a primary cause of lowering of the degree of vacuum of the envelope. When the front substrate and the rear substrate are then cooled so that the degree of vacuum in the vacuum tank is fully enhanced, a getter film for improving and maintaining the degree of vacuum of the envelope is formed on a phosphor screen. Thereafter, the front substrate and the rear substrate are heated again to a temperature at which a sealing material melts, and the front substrate and the rear substrate are combined in a predetermined position as they are cooled so that the sealing material solidifies.

With the vacuum envelope fabricated by this method, a sealing process doubles as a vacuum encapsulation process, and no time is needed to exhaust the interior of the envelope through an exhaust tube. Besides, a very satisfactory degree of vacuum can be obtained.

In performing assembly in a vacuum, however, processing in the sealing process is multiplex, including heating, position alignment, and cooling, and the front substrate and the rear substrate must continue to be kept in the predetermined position for a long time during which the sealing material melts and solidifies. Further, there are problems in productivity and characteristics related to sealing such that the front substrate and the rear substrate easily undergo thermal expansion and thermal contraction to lower the alignment accuracy as they are heated and cooled to be sealed.

Reviewed in Jpn. Pat. Appln. KOKAI Publication No. 2002-319346, on the other hand, is a method (conductive heating) in which a low-melting-point metallic sealing material such as indium, which melts at a relatively low temperature, is filled into a space between a front substrate and a frame body, and the electrically conductive sealing material itself is supplied with current to be heated and melted by the resulting Joule heat, whereby the substrates are coupled together. According to this method, cooling the substrates never requires a very long time, so that the substrates can be joined together to form an envelope in a short time.

By use of this method, however, low-melting-point metal that is melted in a heating process before sealing inevitably flows, thereby causing partial distribution of abundance, depending on the place, so that the conductive heating involves uneven heating. When the low-melting-point metal melts, moreover, the current supply may cause disconnection in a low-melting-point metallic portion.

Since the substrates are sealed together with the indium melted, furthermore, the melted indium may possibly overflow into a display region inside the substrates or a wiring region around the substrates. To solve this problem, for example, the melted indium may be caused positively to flow out through corner portions of the substrates as the substrates are sealed together. If the substrate size is larger, however, the indium near the central portion of each side of the substrates finds it more difficult to move to the corner portions of the substrates. In some cases, the indium may overflow to the inside or outside of the substrates through desired sealing regions on the way. If the indium overflows, it touches wires and the like on the substrates, thereby causing a short circuit or the like. Inevitably, therefore, a large width must be secured for the frame body so that the overflowed indium can be restricted within the width of the frame body. In a flat image display device, however, any other portion than the display region, that is, a picture-frame portion around the display region, should preferably be as narrow as possible, so that the width of the frame body and the sealing width should be minimized.

In the FED, the frame body that is provided between the front substrate and the rear substrate is very narrow and very thin, e.g., as thin as about 1 mm. In joining the frame body to the respective peripheral edge portions of the substrates, in a manufacturing process for the FED, therefore, the frame body is hard to hold and liable to deformation, so that positioning it takes time. In holding the frame body, at the same time, the respective central portions of the sides of the frame body bend or twist, so that the frame body cannot be accurately located with ease. These problems result in an increase in index time during manufacture and entail an increase in cost. Thus, an early improvement is expected.

### BRIEF SUMMARY OF THE INVENTION

This invention has been made in consideration of these circumstances, and its object is to provide an image display device capable of ensuring quick and steady sealing operation for a front substrate and a rear substrate and having a satisfactory degree of vacuum, and a method of manufacturing method the same.

In order to achieve the object, according to an aspect of the invention, there is provided an image display device comprising: an envelope having a front substrate and a rear substrate opposed to each other and a rectangular frame body provided between respective peripheral portions of the front substrate and the rear substrate; and a plurality of pixels formed in the envelope, the frame body having projections which protrude outward in a direction parallel to sides of the frame body from individual corner portions and are configured to be nipped.

According to anther aspect of the invention, there is provided a method of manufacturing, which comprises an envelope having a front substrate and a rear substrate opposed to each other and a frame body in the form of a rectangular frame provided between respective peripheral portions of the front substrate and the rear substrate and a plurality of pixels formed in the envelope, the method comprising: preparing the frame body in the form of a rectangular frame having projections which protrude outward from individual corners; nipping and pulling the projections of the frame body outward, thereby applying a tension to each side portion of the frame body in the longitudinal direction thereof; and positioning and joining the frame body to at least one of the front substrate and the rear substrate with the tension kept applied.

According to the image display device constructed in this manner and the method of manufacturing the same, the projections are provided on the individual corner portions of the frame body, so that the frame body can be easily held by nipping the projections. At the same time, each side portion of the frame body can be kept in a flat state and a stable shape without any distortion or twist by pulling the projections outward to apply a longitudinal tension to each side portion of the frame body. Accordingly, the frame body can be accurately located in a predetermined position with respect to the front substrate or the rear substrate in a short time. Thus, there may be provided the image display device, which ensures steady joining of the frame body, reduction in manufacturing cost, and stable and satisfactory image display, and the manufacturing method therefore.

According to another aspect of the invention, there is provided an image display device comprising: an envelope having a front substrate, a rear substrate opposed to the front substrate, an electrically conductive frame body located between respective peripheral portions of the front substrate and the rear substrate so as to join the front substrate and the rear substrate together, and a sealing material located between the frame body and the front substrate or the rear substrate, the frame body having a plurality of through holes or slits formed penetrating the frame body in a direction perpendicular to the surface of the front substrate.

According to another aspect of the invention, there is provided a method of manufacturing an image display device, which comprises an envelope having a front substrate, a rear substrate opposed to the front substrate, an electrically conductive frame body located between respective peripheral portions of the front substrate and the rear substrate so as to join the front substrate and the rear substrate together, and a sealing material located between the frame body and the front substrate or the rear substrate, the method comprising:
preparing the frame body having a plurality of through holes or slits formed penetrating the frame body in a direction perpendicular to the surface of the front substrate; arranging the front substrate and the rear substrate opposite to each other; arranging the frame body between peripheral edge portions of the respective inner surfaces of the front substrate and the rear substrate and along the respective peripheral edge portions of the front substrate and the rear substrate and arranging an electrically conductive sealing material between the frame body and at least one of the peripheral edge portions of the respective inner surfaces of the front substrate and the rear substrate so as to cover the whole circumference; and heating the frame body by supplying current thereto, thereby melting or softening the sealing material, pressurizing the front substrate and the rear substrate toward each other, and sealing the respective peripheral edge portions of the front substrate and the rear substrate.

According to the image display device constructed in this manner and the method of manufacturing the same, the frame body is provided with the through holes or slits, so that the resistance of the frame body can be made higher than that of a frame body that has neither through holes nor slits. Thus, current for heating to be supplied to the sealing material or the frame body can be reduced to simplify the device configuration or the electrode configuration. Alternatively, the width of the frame body can be widened to increase a joint area, thereby improving the sealing reliability, despite the use of the same current as a conventional one.

According to the arrangement described above, the elasticity of the frame body in a direction parallel to the substrates can be made apparently lower. Thus, a stress that is attributable to the difference in thermal expansion between the frame body and the substrates or the like, which is caused by heating or a change of ambient temperature, can be eased, and the frame body can be aligned with a desired position by a small tension.

According to the foregoing arrangement, moreover, the surface area of the frame body, compared with its volume, can be made large, so that the retention of the sealing material can be enhanced. If the sealing material melts in a poor levelness condition set during manufacture, therefore, there is an advantage that the sealing material cannot be locally distributed on the frame body or flow with ease. Since the heat capacity of the frame body is reduced by a margin corresponding to the through holes or slits, the frame body can be easily heated and cooled in a short time when subjected to conductive heating.

According to an aspect of the invention, there is provided an image display device comprising: an envelope having a front substrate, a rear substrate opposed to the front substrate, an electrically conductive frame body located between respective peripheral portions of the front substrate and the rear substrate so as to join the front substrate and the rear substrate together, and a sealing material located between the frame body and the front substrate or the rear substrate, the frame body having four projections which protrude outward from four corners and at least one projection which protrudes outward from a side portion.

According to another aspect of the invention, there is provided a method of manufacturing an image display device, which comprises an envelope having a front substrate, a rear substrate opposed to the front substrate, an electrically conductive frame body located between respective peripheral portions of the front substrate and the rear substrate so as to join the front substrate and the rear substrate together, and a sealing material located between the frame body and the front substrate or the rear substrate, the method comprising:
preparing the frame body having four projections which protrude outward from four corners and at least one projection which protrudes outward from a side portion; arranging the front substrate and the rear substrate opposite to each other; arranging the frame body between peripheral edge portions of the respective inner surfaces of the front substrate and the rear substrate and along the respective peripheral edge portions of the front substrate and the rear substrate and arranging an electrically conductive sealing material between the frame body and at least one of the peripheral edge portions of the respective inner surfaces of the front substrate and the rear substrate so as to cover the whole circumference; tacking the projections of the frame body to at least one of the peripheral edge portions of the respective inner surfaces of the front substrate and the rear substrate, thereby positioning the frame body in a predetermined position; heating the frame body by current supply after positioning the frame body, thereby melting or softening the sealing material, pressurizing the front substrate and the rear substrate toward each other, and sealing the respective peripheral edge portions of the front substrate and the rear substrate.

According to the image display device constructed in this manner and the method of manufacturing the same, the electrically conductive frame body can be energized to melt or soften the sealing material, whereby the front substrate and the rear substrate can be joined together. If the abundance of the sealing material is partially distributed or if the sealing material melts during current supply, therefore, the electrically conductive frame body can ease or reduce the possibility of uneven heating or disconnection. Further, the frame body can be fixed to the substrates by the projections that protrude from the four corners and the side portions. If the frame body is thermally expanded by current supply, therefore, it can be prevented from being distorted or twisted, and a predetermined frame body position can be maintained. Thus, the sealing operation for the front substrate and the rear substrate can be carried out quickly and steadily, and the image display device having a satisfactory degree of vacuum and the manufacturing method therefore can be provided.

According to an aspect of the invention, there is provided an image display device comprising: an envelope having a front substrate and a rear substrate opposed to each other and a sealing portion which seals respective peripheral edge portions of the front substrate and the rear substrate together, the sealing portion including a frame body and a sealing material which extend along the respective peripheral edge portions of the front substrate and the rear substrate, the frame body having a sectional shape such that a space between the outer surface of the frame body and the inner surface of at least one of the front substrate and the rear substrate varies in the width direction of the frame body, the sealing material being provided between the frame body and the inner surface of at least one of the substrates.

According to another aspect of the invention, there is provided a method of manufacturing an image display device, which comprises an envelope having a front substrate and a rear substrate opposed to each other and a sealing portion which seals respective peripheral edge portions of the front substrate and the rear substrate together, the method comprising:
forming a sealing material layer on at least one of peripheral edge portions of the respective inner surfaces of the front substrate and the rear substrate so as to cover the whole circumference; arranging the front substrate and the rear substrate, having the sealing material layer thereon, opposite to each other; arranging a frame body, which extends along the respective peripheral edge portions of the front substrate and the rear substrate, between the peripheral edge portions of the respective inner surfaces of the front substrate and the rear substrate, the frame body having a sectional shape such that a space between the outer surface of the frame body and the peripheral edge portion of the inner surface of at least one of the front substrate and the rear substrate varies in the width direction of the frame body, heating the sealing material layer to melt or soften a sealing material, pressurizing the front substrate and the rear substrate toward each other, and sealing the respective peripheral edge portions of the front substrate and the rear substrate.

According to the image display device constructed in this manner and the method of manufacturing the same, the melted sealing material flows in wide regions between the substrates and the frame body when the front substrate and the rear substrate to be sealed are joined together and pressurized under a given pressure. Thus, sealing can be performed without causing the melted sealing material to overflow into an image display region or a wiring region or without causing any trouble, such as a wiring short. At the same time, it is unnecessary to secure a large sealing width in consideration of the overflow of the sealing material, so that a narrow-frame image display device can be obtained.

### BRIEF DESCRIPTION OF THE SEVERAL VIEWS OF THE DRAWING

FIG. 1 is a perspective view showing an FED according to a first embodiment of this invention;

FIG. 2 is a perspective view showing the FED with its front substrate off;

FIG. 3 is a sectional view taken along line III-III of FIG. 1;

FIG. 4 is a plan view showing a frame body of the FED;

FIG. 5 is a plan view showing a phosphor screen of the FED;

FIG. 6 is a diagram schematically showing a vacuum processor used in the manufacture of the FED;

FIG. 7 is a sectional view showing a state in which a front substrate, frame body, and rear substrate are opposed to one another in the vacuum processor;

FIG. 8 is a sectional view showing a state in which metal plate electrodes are arranged between the front substrate, frame body, and rear substrate in the vacuum processor;

FIG. 9 is an enlarged sectional view showing a state in which a metal plate electrode is held between the rear substrate and the frame body;

FIG. 10 is a plan view showing a frame body according to a modification of this invention;

FIG. 11 is a plan view showing a frame body according to another modification of this invention;

FIG. 12 is a plan view showing a frame body according to still another modification of this invention;

FIG. 13 is a perspective view showing an appearance of an FED according to a second embodiment of this invention;

FIG. 14 is a perspective view showing a configuration of the rear substrate side of the FED of FIG. 13;

FIG. 15 is a sectional view of the FED taken along line XV-XV of FIG. 13;

FIG. 16 is an enlarged plan view showing a part of a frame body of the FED;

FIG. 17 is a sectional view showing a state in which a front substrate and a rear substrate are opposed to each other in a manufacturing process for the FED;

FIG. 18 is a plan view showing a frame body of Example 2 of this invention;

FIG. 19 is a sectional view of the frame body of Example 2;

FIG. 20 is a plan view showing a frame body of Example 3 of this invention;

FIG. 21 is a plan view showing a frame body of Example 4 of this invention;

FIG. 22 is a plan view showing a frame body of Example 5 of this invention;

FIG. 23 is a perspective view showing an appearance of an FED according to a third embodiment of this invention;

FIG. 24 is a perspective view showing a configuration of the rear substrate side of the FED according to the third embodiment;

FIG. 25 is a sectional view of the FED taken along line XXV-XXV of FIG. 23;

FIG. 26 is an enlarged plan view showing a part of a frame body of the FED;

FIG. 27 is a plan view showing a state in which the frame body is mounted on a rear substrate according to the third embodiment;

FIG. 28 is a plan view showing a frame body according to Example 6 of this invention;

FIG. 29 is a plan view showing a frame body according to Example 7 of this invention;

FIG. 30 is a perspective view showing an FED according to a fourth embodiment of this invention;

FIG. 31 is a perspective view showing the FED according to the fourth embodiment with its front substrate off;

FIG. 32 is a sectional view taken along line XXXII-XXXII of FIG. 30;

FIG. 33 is a sectional view showing a state in which the front substrate and a rear substrate are opposed to each other in a manufacturing process for the FED;

FIG. 34 is a sectional view showing a first modification of a frame body of the fourth embodiment;

FIG. 35 is a sectional view showing a second modification of the frame body of the fourth embodiment;

FIG. 36 is a sectional view showing a third modification of the frame body of the fourth embodiment;

FIG. 37 is a sectional view showing a fourth modification of the frame body of the fourth embodiment;

FIG. 38 is a sectional view showing a fifth modification of the frame body of the fourth embodiment; and

FIG. 39 is a sectional view showing a sixth modification of the frame body of the fourth embodiment.

### DETAILED DESCRIPTION OF THE INVENTION

A first embodiment in which an image display device of this invention is applied to an FED will now be described in detail with reference to the drawings.

As shown in FIGS. 1 to 4, this FED comprises a front substrate 11 and a rear substrate 12, which are formed of a rectangular glass plate each and are opposed to each other with a gap of 1 mm between them. The diagonal dimension of each substrate is, for example, 10 inches. The rear substrate 12 is larger than the front substrate 11, and a plurality of wires 19 for inputting video signals are drawn out of the outer peripheral portion of the rear substrate. The front substrate 11 and the rear substrate 12 have their respective peripheral edge portions joined together by a rectangular frame body 13 that serves as a side wall, and constitute a flat, rectangular vacuum envelope 10, which is internally kept in a vacuum state.

The frame body 13 has projections 18a, 18b, 18c and 18d that protrude individually outward from its corner portions in directions parallel to diagonal axes 37 and 38. The frame body 13 is sealed to the rear substrate 12 and the front substrate 11 with sealing materials 21 of low-melting-point metal or the like.

In a sealed state, the projections 18a, 18b, 18c and 18d of the frame body 13 protrude individually outward from the front substrate 11 and extend close to the corners of the rear substrate 12. As mentioned later, the projections 18a, 18b, 18c and 18d can serve as holding portions for positioning the frame body in manufacturing processes for the FED.

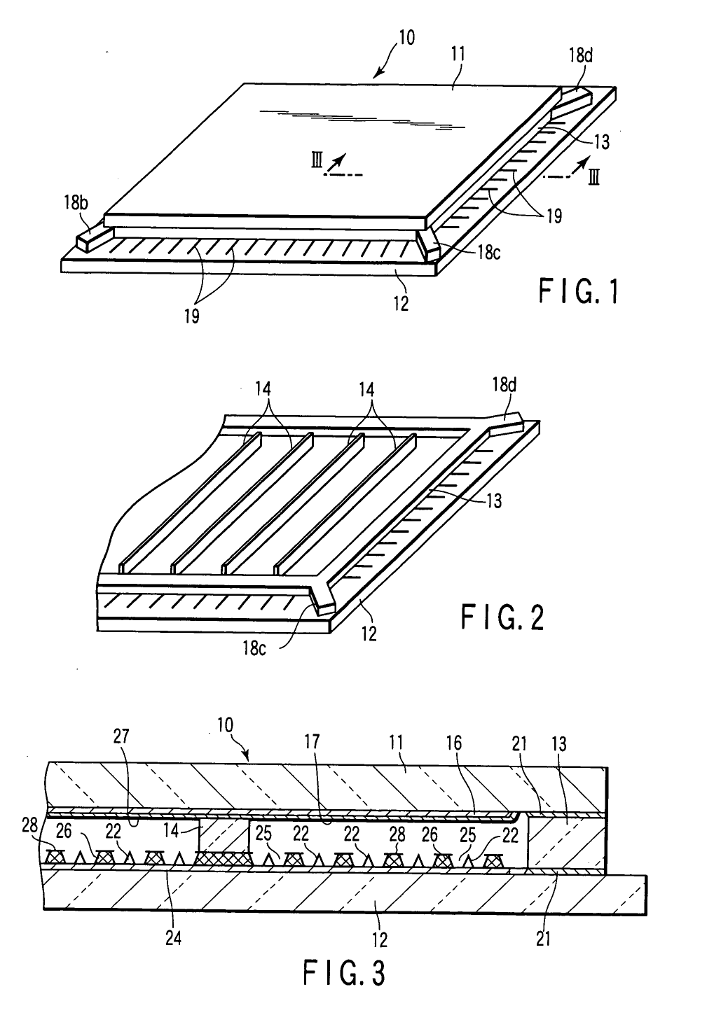

As shown in FIGS. 2 and 3, the vacuum envelope 10 has therein a plurality of plate-like spacers 14 for use as support members, which serve to bear an atmospheric load that acts on the front substrate 11 and the rear substrate 12. These spacers 14 are arranged parallel to the short sides of the vacuum envelope 10 and spaced in a direction parallel to the long sides. The spacers 14 are not restricted particularly to this shape, and columnar spacers or the like may be used alternatively, for example.

A phosphor screen 16 shown in FIG. 5 is formed on the inner surface of the front substrate 11. The phosphor screen 16 is formed by arranging red, green, and blue stripe-shaped phosphor layers R, G and B and a black light absorbing layer 20 as a non-luminescent portion that is situated between these phosphor layers. The phosphor layers extend parallel to the short sides of the vacuum envelope 10 and are spaced in a direction parallel to the long sides. A metal back 17, which is formed of, for example, an aluminum layer, and a getter film 27 of barium are successively formed overlapping each other on the phosphor screen 16.

Provided on the inner surface of the rear substrate 12, as shown in FIG. 3, are a large number of electron emitting elements 22 for use as electron emission sources that individually emit electron beams and excite the phosphor layers of the phosphor screen 16. These electron emitting elements 22 are arranged in a plurality of columns and a plurality of rows corresponding to pixels, individually. More specifically, an electrically conductive cathode layer 24 is formed on the inner surface of the rear substrate 12. An insulating film 26 having a large number of cavities 25 is formed on this electrically conductive cathode layer. A gate electrode 28 of molybdenum, niobium, or the like is formed on the insulating film 26. On the inner surface of the rear substrate 12, the cone-shaped electron emitting elements 22 of molybdenum or the like are provided individually in the cavities 25.

In the FED constructed in this manner, the video signals are inputted to the electron emitting elements 22 and the gate electrode 28 that are formed in a simple matrix. Based on the electron emitting elements 22, a gate voltage of +100 V is applied when the luminance is highest. A voltage of +10 kV is applied to the phosphor screen 16. Thus, electron beams are emitted from the electron emitting elements 22. The intensity of the electron beams emitted from the electron emitting elements 22 are modulated by a voltage of the gate electrode 28. An image is displayed as the electron beams excite the phosphor layers of the phosphor screen 16 to glow.

The following is a detailed description of a manufacturing method for the FED constructed in this manner.

First, the phosphor screen is applied to a plate glass that forms the front substrate 11. A plate glass that is as large as the front substrate 11 is prepared, and a phosphor stripe pattern is formed on the plate glass with a plotter machine. The plate glass having the phosphor stripe pattern thereon and the plate glass for the front substrate are placed on a positioning jig, set on an exposure stage, and exposed and developed, whereupon the phosphor screen is formed. Then, the metal back 17, an aluminum film, is formed overlapping the phosphor screen 16.

On the other hand, the electron emitting elements 22 are formed on a plate glass for the rear substrate. In this case, the electrically conductive cathode layer 24 is formed on the plate glass, and the insulating film 26, a silicon dioxide film, is formed on the electrically conductive cathode layer by the thermal oxidation method, CVD method, or sputtering method, for example.

Thereafter, a metal film of molybdenum or niobium for gate electrode formation is formed on the insulating film 26 by the sputtering method or electron beam vapor deposition method, for example. Then, a resist pattern of a shape corresponding to the gate electrode to be formed is formed on this metal film by lithography. The metal film is etched by the wet etching method or dry etching method using this resist pattern as a mask, whereupon the gate electrode 28 is formed.

Then, the insulating film 26 is etched by the wet etching method or dry etching method using the resist pattern and the gate electrode 28 as masks, whereupon the cavities 25 are formed. After the resist pattern is removed, a separation layer of, e.g., aluminum or nickel is formed on the gate electrode 28 by electron beam vapor deposition in a direction at a given angle to the surface of the rear substrate 12. Thereafter, a material for cathode formation, e.g., molybdenum, is deposited on the surface of the rear substrate 12 at right angles thereto by the electron beam vapor deposition method. Thereupon, the electron emitting elements 22 are formed inside the cavities 25, individually. Subsequently, the separation layer, along with the metal film formed thereon, is removed by the liftoff method.

Further, the plate-like spacers 14 are sealed on the rear substrate 12 with low-melting-point glass.

Indium as the sealing material 21 is applied to the rear substrate 12 to which the spacers 14 are sealed in the aforesaid manner, the front substrate 11 on which the phosphor screen 16 is formed, and a sealed surface of the frame body 13. In this case, indium is applied to the inner surfaces of the respective peripheral edge portions of the rear substrate 12 and the front substrate 11 and both surfaces of the frame body 13. Thereafter, they are opposed to each other with a given gap between them as they are put into a vacuum processor 100. For example, the vacuum processor 100 shown in FIG. 6 is used for the aforesaid series of processes.

The vacuum processor 100 has a loading chamber 101, baking and electron beam cleaning chamber 102, cooling chamber 103, vapor deposition chamber 104 for getter film, assembly chamber 105, cooling chamber 106, and unloading chamber 107, which are arranged side by side in the order named. Each of these chambers is constructed as a processing chamber capable of vacuum processing, and all these chambers are evacuated during the manufacture of the FED. Each two adjacent processing chambers are connected to each other by a gate valve or the like.

The rear substrate 12, frame body 13, and front substrate 11 described above are put into the loading chamber 101, and are delivered to the baking and electron beam cleaning chamber 102 after a vacuum atmosphere is formed in the loading chamber 101. In the baking and electron beam cleaning chamber 102, the front substrate, rear substrate, and frame body are heated to a temperature of 350° C., whereby a gas adsorbed by the respective surfaces of these members is released.

The moment the members are heated, moreover, an electron beam generator (not shown) that is attached to the baking and electron beam cleaning chamber 102 applies an electron beam to a phosphor screen surface of the front substrate 11 and an electron emitting element surface of the rear substrate 12. Since this electron beam is deflected for scanning by a deflector that is mounted on the outside of the electron beam generator, the phosphor screen surface and the electron emitting element surface can be entirely cleaned with the electron beam.

After the heating and electron beam cleaning, the front substrate, rear substrate, and frame body are delivered to the cooling chamber 103 and cooled to a temperature of about 100° C., for example. Subsequently, the front substrate, rear substrate, and frame body are delivered to the vapor deposition chamber 104 for getter film formation, whereupon the barium film 27 is formed as the getter film on the outside of the metal back 17 by vapor deposition. Since this barium film can prevent the surface from being soiled by oxygen or carbon, an active state can be maintained.

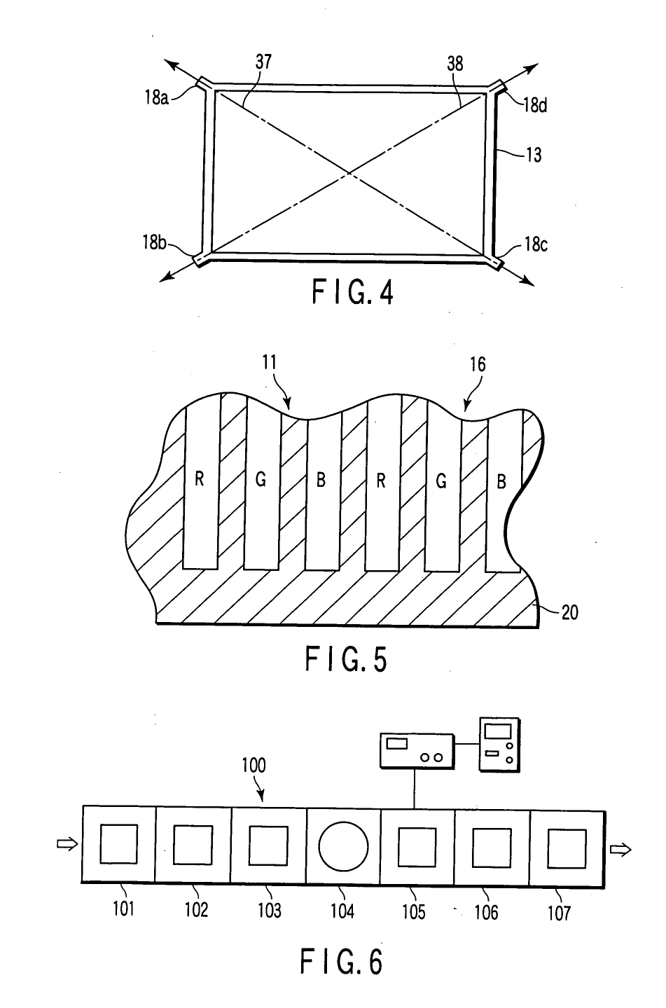

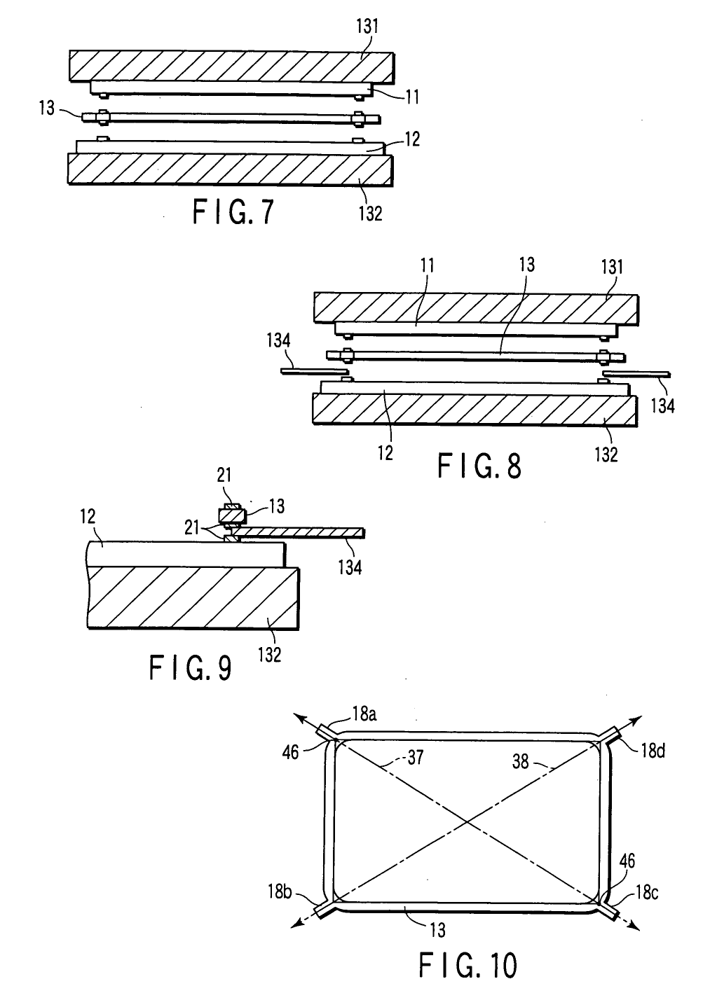

Subsequently, the rear substrate 12, frame body 13, and front substrate 11 are delivered to the assembly chamber 105. In this assembly chamber 105, as shown in FIG. 7, the front substrate 11 and the rear substrate 12 are opposed to each other as they are held by hotplates 131 and 132, respectively, in the assembly chamber. Further, the frame body 13 is pulled outward along the diagonal axes 37 and 38, as shown in FIG. 4, with the projections 18a, 18b, 18c and 18d of the frame body 13 nipped by chucking mechanisms (not shown). Thereupon, tensions along the longitudinal direction are applied to long and short side portions of the frame body. Thus, the frame body 13 can be kept flat and in a given shape without being distorted or twisted when they are held between the front substrate 11 and the rear substrate 12.

After metal plate electrodes 134 in the shape of a flat plate each are then inserted between the rear substrate 12 and the frame body 13, as shown in FIG. 8, the frame body is lowered toward the rear substrate. When the rear substrate 12 and the frame body 13 are brought close to each other so that the gap between them is about 1 mm, the frame body is positioned with respect to the rear substrate. When this is done, the frame body 13 is kept under an outward tension in the diagonal directions, so that it can be kept in a stable flat shape without being bent or twisted during the positioning process. Thus, the frame body 13 can be positioned easily and accurately with respect to the rear substrate 12. Since the projections 18a, 18b, 18c and 18d protrude outward from the frame body 13, the frame body 13 can be easily chucked, conveyed, and positioned even in the assembly chamber 105 by the use of these projections.

After the positioning is completed, the frame body 13 is lowered further. Thereupon, the metal plate electrode 134 is sandwiched between the sealing material 21 on the frame body 13 and the sealing material 21 on the rear substrate 12 as it touch the sealing materials, as shown in FIG. 9.

After another metal plate electrode (not shown) having the same shape as the aforesaid metal plate electrode is then inserted between the frame body 13 and the front substrate 11, the front substrate is lowered toward the frame body. When the front substrate 11 and the frame body 13 are brought close to each other so that the gap between them is about 1 mm, the front substrate 11 is positioned with respect to the rear substrate 12. After the positioning, the front substrate 11 is further lowered, and the metal plate electrode is sandwiched between the sealing material 21 on the frame body 13 and the sealing material 21 on the front substrate 11 and brought into contact with the sealing materials.

Subsequently, a dc current of 140 A is applied to the metal plate electrode 134 and the other metal plate electrode with a force of pressure of about 50 kgf applied to the front substrate 11 and the rear substrate 12 from both sides. Thereupon, this current flows through the indium as the sealing materials 21, whereby the indium is heated and melted. Thus, the front substrate 11, rear substrate 12, and frame body 13 are joined together with the indium and form the vacuum envelope.

After the envelope formed in this manner is cooled to normal temperature in the cooling chamber 106, it is taken out through the unloading chamber 107. The FED is completed in these processes.

According to the FED constructed in this manner and the method of manufacturing the FED, the surface-adsorbed gas can be thoroughly released by a combination of baking and electron beam cleaning with the rear substrate 12, frame body 13, and front substrate 11 sealed in the vacuum atmosphere. Thus, a satisfactory gas adsorption effect can be maintained without causing the getter film to be oxidized. Since the frame body 13 is provided with the projections 18a, 18b, 18c and 18d that can be nipped, the frame body 13 can be easily chucked and conveyed even in the vacuum device. At the same time, the frame body 13 can be kept in a stable shape without distortion or twist in a sealing process by nipping and pulling the projections 18a, 18b, 18c and 18d outward and holding the frame body 13 with a tension applied to each its side portion. Thereupon, the frame body 13 can be positioned easily and accurately with respect to the substrates. Thus, sealing operation can be completed in a short time, so that the manufacturing cost can be reduced, and the mass-producibility can be improved. Since the frame body can be joined with stability, moreover, the resulting FED can enjoy stable satisfactory image display.

In the case of the first embodiment described above, the corner portions of the frame body 13 are square. However, the present invention is also applicable to a case where the corner portions of a frame body are curved. In this case, as shown in FIG. 10, intersections 46 of extensions of inner sides of the frame body 13 are regarded as vertexes, and lines that connect the opposite vertexes as diagonal axes 37 and 38, individually. Projections 18a, 18b, 18c and 18d are provided extending outward along the diagonal axes 37 and 38 from the corner portions of the frame body 13. In the manufacture of an FED, as in the case of the foregoing embodiment, the frame body 13 is positioned with longitudinal tensions applied to its side portions by nipping and pulling the projections 18a, 18b, 18c and 18d outward.

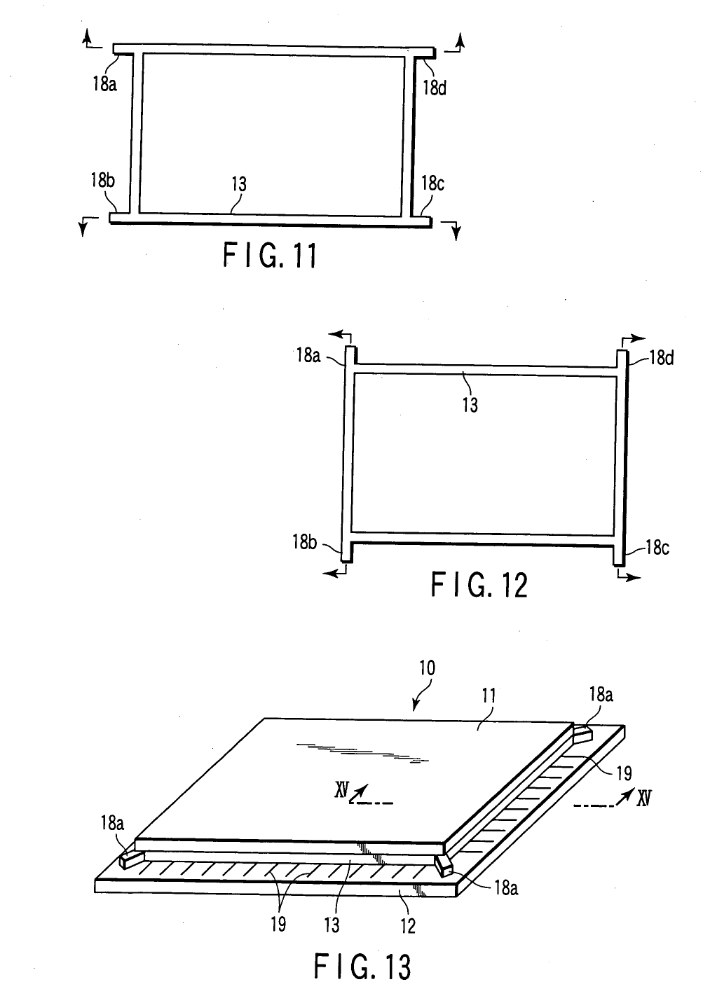

The projections 18a, 18b, 18c and 18d of the frame body 13 may be formed extending parallel to the long sides of the frame body from the individual corner portions of the frame body, as shown in FIG. 11, or extending parallel to the short sides of the frame body from the individual corner portions of the frame body, as shown in FIG. 12. In either case, as in the foregoing first embodiment, the projections 18a, 18b, 18c and 18d are nipped and pulled outward so that longitudinal tensions are applied to long side portions and short side portions of the frame body 13. Thus, the frame body can be positioned easily and accurately without any distortion or twist. Besides, the same functions and effects as those of the first embodiment can be also obtained from the modifications shown in FIGS. 10 to 12.

In the first embodiment, the frame body may be positioned with respect to the frame body, or the substrates and the frame body may be put into the vacuum processor with the electrodes for energizing the sealing materials attached to the substrates. The component members may be joined and sealed in any other atmospheric environment than the vacuum atmosphere.

The following is a detailed description of an FED according to a second embodiment of this invention.

As shown in FIGS. 13 to 15, the FED comprises a front substrate 11 and a rear substrate 12, which are formed of a rectangular glass as an insulating substrate each and are opposed to each other with a gap of 1 to 2 mm between them. The front substrate 11 and the rear substrate 12 have their respective peripheral edge portions joined together by an electrically conductive rectangular frame body 13, and constitute a flat, rectangular vacuum envelope 10, which is internally kept in a vacuum state. In the present embodiment, the frame body 13 and a joint surface situated on the peripheral edge portion of the inner surface of the front substrate 11 are joined together with an electrically conductive sealing material 21a, which will be mentioned later, and the frame body 13 and a joint surface situated on the peripheral edge portion of the inner surface of the rear substrate 12 with a sealing material 21b. Preferably, the sealing materials are materials that melt or soften at 300° C. or less, and a low-melting-point metal, such as indium, indium alloy, etc., may be used for them. One of the joint surfaces and the frame body 13 may be previously joined with a low-melting-point sealing material such as fritted glass.

The frame body 13 has projections 18a that protrude individually outward from corner portions. These projections function as electrodes during manufacture and serve as holding portions for holding and positioning the frame body. Independent electrodes may be attached instead of providing the projections 18a.

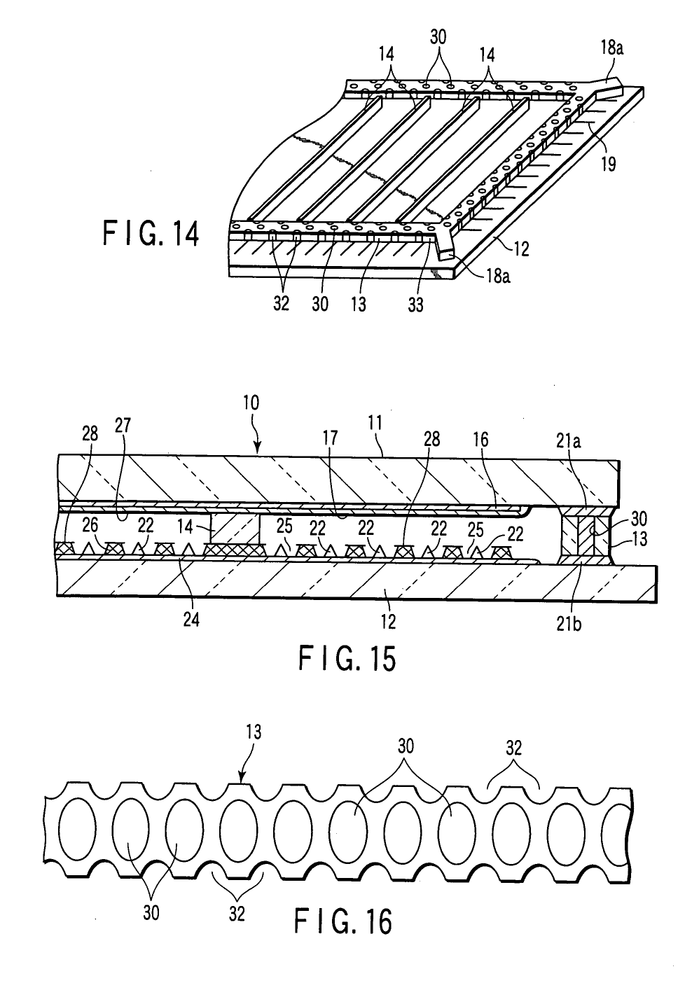

As shown in FIGS. 14, 15 and 16, the frame body 13 has a large number of through holes 30 arranged like meshes of a net and a plurality of slits 32 that open in side faces of the frame body. The through holes 30 and the slits 32 are formed individually penetrating the front substrate 11 and the rear substrate 12 at right angles to their surfaces, and are arranged at given spaces throughout the circumference of the frame body 13. Preferably, the frame body 13 is formed of a material that has a melting point of 500° C. or more, and a material that contains at least one of elements including Ti, Fe, Cr, Ni, Al and Cu may be used for it.

As shown in FIGS. 14 and 15, a plurality of plate-like spacers 14 are provided in the vacuum envelope 10 in order to bear the atmospheric load that acts on the front substrate 11 and the rear substrate 12. These spacers 14 are arranged parallel to the short sides of the vacuum envelope 10 and at given spaces in the direction parallel to the long sides. The spacers 14 are not restricted particularly to this shape, and columnar spacers or the like may be used alternatively, for example. As in the first embodiment, a phosphor screen 16, which has phosphor layers R, G and B and a light absorbing layer, a metal back 17, and a getter film 27 are formed overlapping one another on the inner surface of the front substrate 11.

Provided on the inner surface of the rear substrate 12, as shown in FIG. 15, are a large number of electron emitting elements 22 for use as electron emission sources that drive electrons against the phosphor layers R, G and B to excite them. The electron emitting elements 22 are located in positions opposite the individual phosphor layers R, G and B, and emit electron beams toward their corresponding phosphor layers. A large number of wires 19 that supply driving signals to the electron emitting elements 22 are formed in a matrix on the inner surface of the rear substrate 12. The respective end portions of the wires 19 are drawn out onto the peripheral edge portion of the rear substrate.

The following is a description of the manufacturing method and a manufacturing apparatus for the FED constructed in this manner.

First, the front substrate 11 is prepared having the phosphor screen 16 formed on its inner surface, and indium as the sealing material 21a is spread in the shape of a frame on a joint surface situated on the inner surface of the front substrate and outside the phosphor screen. The rear substrate 12 is prepared having a large number of electron emitting elements 22 formed on its inner surface, and the spacers 14 for securing the gap between the front substrate 11 and the rear substrate 12 are attached during assembly. Indium as the sealing material 21b is spread in the shape of a frame on a joint surface situated on the inner surface of the rear substrate 12 and at an outside peripheral edge portion of the electron emitting elements 22. Further, the electrically conductive frame body 13 is located overlapping the indium. The projections 18a that serve as electrodes through which current for conductive heating flows are integrally formed in advance on four corner portions of the frame body 13. After the frame body is aligned with respect to the indium applied to the rear substrate 12, the projections 18a are fixed individually to the four corners of the rear substrate 12.

In this case, the front substrate 11 and the rear substrate 12 are loaded with the indium. Alternatively, however, the frame body 13 may be loaded with the indium, or the front substrate 11, rear substrate 12, and frame body 13 may be loaded individually.

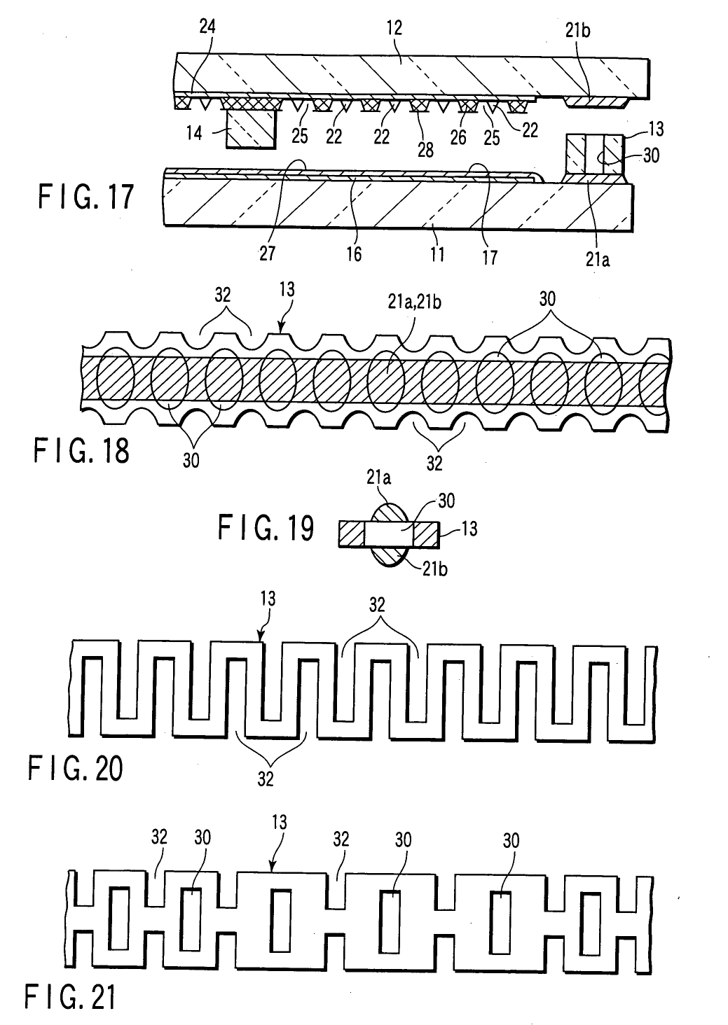

Then, the rear substrate 12 and the front substrate 11, having the frame body 13 placed on the sealing material 21a, are opposed to each other at a given distance as they are held by a jig or the like with their respective joint surfaces facing each other, as shown in FIG. 17. When this is done, the front substrate 11 is located under the rear substrate 12 with its face upward, for example. In this state, the front substrate 11 and the rear substrate 12 are put into a vacuum processor. As in the first embodiment, the vacuum processor 100 shown in FIG. 6 is used as this vacuum processor.

First, the front substrate 11 and the rear substrate 12 are put into the loading chamber 101, and are delivered to the baking and electron beam cleaning chamber 102 after a vacuum atmosphere is formed in the loading chamber 101. In the baking and electron beam cleaning chamber 102, the front substrate 11 and the rear substrate 12 are fully degassed by heating when a high degree of vacuum of about 10⁻⁵ Pa is attained. The heating temperature is set to about 200° C. to 500° C. as required. This is done in order to reduce the speed of gas discharge from the inner wall of the resulting vacuum envelope that lowers the degree of vacuum, thereby preventing properties from being degraded by residual gas.

The moment the members are heated in the baking and electron beam cleaning chamber 102, moreover, the electron beam generator (not shown) that is attached to the baking and electron beam cleaning chamber 102 applies an electron beam to the phosphor screen surface of the front substrate 11 and the electron emitting element surface of the rear substrate 12. Since this electron beam is deflected for scanning by the deflector that is mounted on the outside of the electron beam generator, the phosphor screen surface and the electron emitting element surface can be entirely cleaned with the electron beam.

After the heating and electron beam cleaning, the front substrate 11 and the rear substrate 12 are delivered to the cooling chamber 103 and cooled to a temperature of about 100° C., for example. Subsequently, the front substrate 11 and the rear substrate 12 are delivered to the vapor deposition chamber 104 for getter film, whereupon a barium film is formed as the getter film on the phosphor screen and the metal back by vapor deposition. This barium film can prevent the surface from being soiled by oxygen or carbon, thereby maintaining an active state.

Then, in the assembly chamber 105, the front substrate 11 and the rear substrate 12 are highly accurately positioned and lapped on each other so that the phosphor screen 16 face the electron emitting elements 22. When this is done, the frame body 13 is sandwiched between the sealing material 21a on the peripheral edge portion of the front substrate 11 and the sealing material 21b on the peripheral edge portion of the rear substrate 12, and the projections 18a that protrude individually from the four corners of the frame body 13 are brought into contact with device-side electrodes.

In this state, a given current is supplied to the frame body 13 and the sealing materials 21a and 21b through the projections 18a so that the indium is heated to be melted, and the front substrate 11 and the rear substrate 12 are pressurized in a direction to approach each other. In this heating by current supply, only the frame body 13 and the sealing materials 21a and 21b are mainly heated, so that the heating can be achieved in a short time, and extra thermal expansion of the front substrate 11 or the rear substrate 12 cannot easily occur. If the current supply is stopped, thereafter, heat from the frame body 13 and the sealing materials 21a and 21b thermally diffuses into the front substrate 11 or the rear substrate 12. Thus, the indium is cooled and solidified to complete the sealing in a short time.

After the vacuum envelope 10 formed in this manner is cooled to normal temperature in the cooling chamber 106, it is taken out through the unloading chamber 107. The FED is completed in these processes.

According to the FED constructed in this manner, the frame body 13 has through holes 30 arranged like meshes of a net and slits 32. Therefore, the resistance of the frame body 13 can be made higher than that of a frame body that is provided with neither the through holes 30 nor the slits 32. Thus, the frame body 13 need not be restricted to a narrow width lest its resistance be too low, so that the frame width can be increased to improve the sealing reliability. At the same time, a current that is required by the conductive heating through the frame body 13 for sealing can be reduced, so that thermal expansion of the heated frame body can be restrained.

The frame body 13, compared with the one that is provided with neither the through holes 30 nor the slits 32, is flexible, having great elasticity along the longitudinal direction of each side, that is, in a direction parallel to the surfaces of the substrates. Thus, the problem of the frame body 13 being thermally expanded and twisted by the conductive heating can be solved. For a thermal change, such as a change of ambient temperature or the like, at the same time, an effect to ease the stress of the frame body 13 can be obtained, so the sealing reliability is improved. If the sealing materials 21a and 21b are melted, moreover, the retention of the sealing materials can be improved, so that the sealing materials can be prevented from flowing out or being partially distributed. Thus, the frame body 13 can be sealed uniformly throughout its circumference.

In the manner described above, the sealing operation for the front substrate and the rear substrate can be carried out quickly and steadily, and the FED having a satisfactory degree of vacuum can be obtained.

The following is a description of a plurality of examples to which the second embodiment is applied.

### EXAMPLE 1

The following is a description of an example in which the configuration shown in FIGS. 13 to 16 is applied to an FED display device for a 30-inch TV. Its principal configuration is the same as the one described in connection with the foregoing second embodiment.

A front substrate 11 and a rear substrate 12 are formed of a glass plate of 2.8-mm thickness each. Indiums 21a and 21b of 0.2-mm thickness and 3-mm width each are arranged individually on the respective peripheral edge portions of the front substrate 11 and the rear substrate 12. As shown in FIGS. 14 and 16, a frame body 13 is a nickel alloy of 5-mm width and 2-mm thickness that is bored with through holes 30 having elliptic diameters of φ2 to 3 mm and arranged like meshes of a net and slits 32 having a substantially semicircular cross section. Thus, the resistance of the frame body 13 is substantially twice as high as that of a frame body that has neither holes nor slits, and the mass of the former is about half of that of the latter. Further, projections 18a are formed individually at the four corners of the frame body 13 and serve both as the electrodes for conduction current and as the portions to be fixed to the rear substrate 12. These fixed portions allow the frame body 13 to be lapped on the indium 21b on the peripheral edge portion of the rear substrate 12.

When the substrate temperature attained 120° C. after the front substrate 11 and the rear substrate 12 were put into a vacuum tank and degassed in the vacuum tank so that the getter film was formed, the front substrate 11 and the rear substrate 12 were aligned with predetermined positions so that the frame body 13 was sandwiched between the indiums 21a and 21b on the peripheral edge portion, and were pressurized under a load of about 20 kgf.

In this state, 300 A was supplied to the projections 18a of the frame body 13 for 30 seconds. As this was done, the indiums 21a and 21b were heated to about 160° C. and melted. When the current supply was completed, heat from the frame body 13 and the indiums 21a and 21b quickly thermally diffused into the substrates and the like, whereupon the indiums were cooled and solidified. An FED was obtained by taking out the front substrate 11 and the rear substrate 12 in about 300 seconds thereafter.

By thus providing the frame body 13 with the mesh-like hoes and the slits, the magnitude of heating current was able to be restricted to a practical level, and the frame width was able to be increased to improve the sealing reliability. Since the mesh structure absorbed thermal expansion of the frame body 13, moreover, the frame body was able to be prevented from being twisted by conductive heating.

### EXAMPLE 2

The principal configuration of Example 2 is the same as that of Example 1.

In Example 2, as shown in FIGS. 18 and 19, the opposite sides of a frame body 13 were loaded individually with indiums 21a and 21b during manufacture, and a front substrate 11 and a rear substrate 12 were not loaded with any sealing members. The front substrate 11, rear substrate 12, and the frame body 13 were kept upright as they all were put into a vacuum assembly tank (longitudinal conveyance). Thereafter, an FED was formed by the same processes of the foregoing second embodiment.

If the longitudinal conveyance is adopted in this manner, a vacuum assembling device can be realized having satisfactory spaces and maintainability. Conventionally, there was a problem that the indiums were caused to flow out by heating in a degassing process. According to the present example, however, the frame body 13, bored with mesh-like through holes 30 and slits 32, was loaded with the indiums, whereby the indiums were located locally in the through holes 30. When the individual component members were heated by longitudinal conveyance, the indiums were able to be held on the frame body without flowing.

### EXAMPLE 3

The principal configuration of Example 3 is the same as that of Example 1.

In Example 3, as shown in FIG. 20, a frame body 13 was provided with a large number of straight slits 32, and the frame body 13 was formed substantially in the shape of a bellows as a whole. The slits 32 are formed at right angles to the respective surfaces of the front substrate and the rear substrate, and are formed extending alternately from the opposite side faces of the frame body 13. Also with use of these slits 32, the same effects of Examples 1 and 2 that were provided with the through holes 30 were able to be obtained.

### EXAMPLE 4

The principal configuration of Example 4 is the same as that of Example 1.

In Example 4, as shown in FIG. 21, the formation densities of through holes 30 and slits 32 in a frame body 13 are varied depending on the regions of the frame body. In this way, the resistance of the frame body 13 can be changed partially. Thus, conductive heating of a desired region can be controlled with a local resistance change of the frame body 13. Even in a specific portion such as a corner portion, which cannot be easily melted due to heat dissipation, therefore, the sealing materials can be melted at the same timing as other parts. Thus, the respective peripheral edge portions of the front substrate and the rear substrate can be sealed uniformly and steadily throughout the circumference.

### EXAMPLE 5

The principal configuration of Example 5 is the same as that of Example 1.

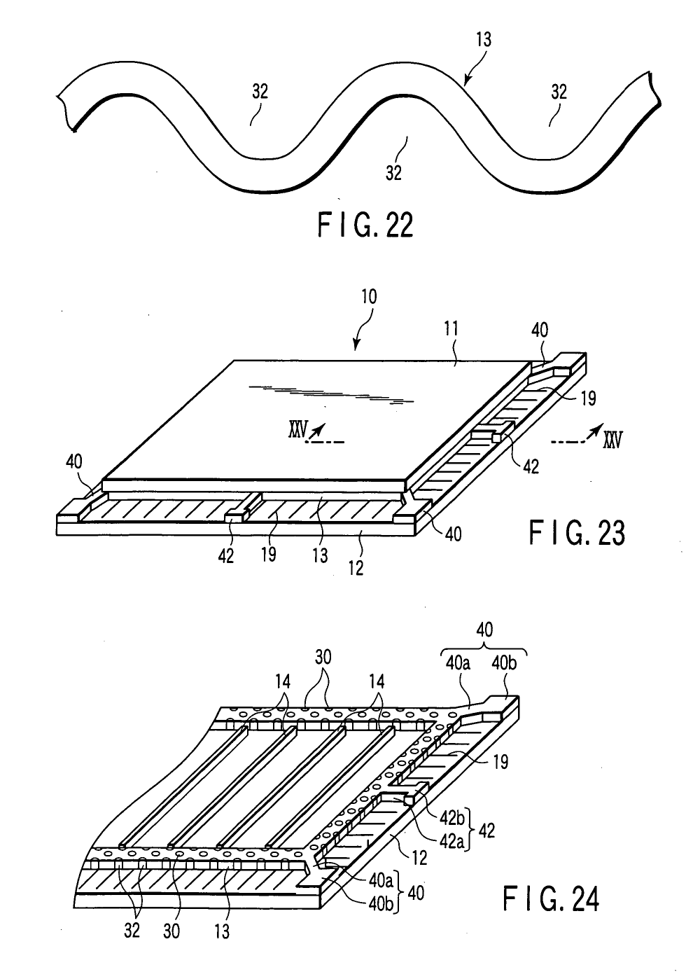

In the present example, as shown in FIG. 22, a frame body 13 is provided with substantially semicircular slits 32 that are arranged alternately, and the frame body 13 is formed substantially in the shape of a bellows as a whole. Also with use of these slits 32, the same effects of Examples 1 and 2 that were provided with the through holes 30 were able to be obtained.

In the second embodiment, moreover, the frame body is provided with both the through holes and the slits. Alternatively, however, the frame body may be provided with only the through holes or the slits.

The following is a detailed description of an FED according to a third embodiment of this invention.

As shown in FIGS. 23 to 25, the FED comprises a front substrate 11 and a rear substrate 12, which are formed of a rectangular glass as an insulating substrate each and are opposed to each other with a gap of 1 to 2 mm between them. The front substrate 11 and the rear substrate 12 have their respective peripheral edge portions joined together by an electrically conductive rectangular frame body 13, and constitute a flat, rectangular vacuum envelope 10, which is internally kept in a vacuum state. The frame body 13 and a joint surface situated on the peripheral edge portion of the inner surface of the front substrate 11 are joined together with an electrically conductive sealing material 21a, which will be mentioned later, and the frame body 13 and a joint surface situated on the peripheral edge portion of the inner surface of the rear substrate 12 with a sealing material 21b. Preferably, the sealing materials 21a and 21b are materials that melt or soften at 300° C. or less, and a low-melting-point metal, such as indium, indium alloy, etc., may be used for them. One of the joint surfaces and the frame body 13 may be previously joined with a low-melting-point sealing material such as fritted glass.

The frame body 13 has four projections 40 that protrude individually outward from four corner portions and projections 42 that protrude outward from the respective central portions of individual sides. The projections 40 and 42 have elongated stem portions 40a and 42a protruding from the corner or side portions of the frame body 13 and fixed portions 40b and 42b that are formed individually on the respective extended ends of the stem portions and are wider than the step portions. The projections 40 and 42 are joined to the peripheral edge portion of the inner surface of the front substrate 11 and the peripheral edge portion of the inner surface of the rear substrate 12 with the sealing materials 21a and 21b. Thus, the frame body 13 is held in a predetermined joint position relative to the front substrate 11 and the rear substrate 12. The projections 40 function as electrodes during manufacture and serve as holding portions for holding and positioning the frame body.

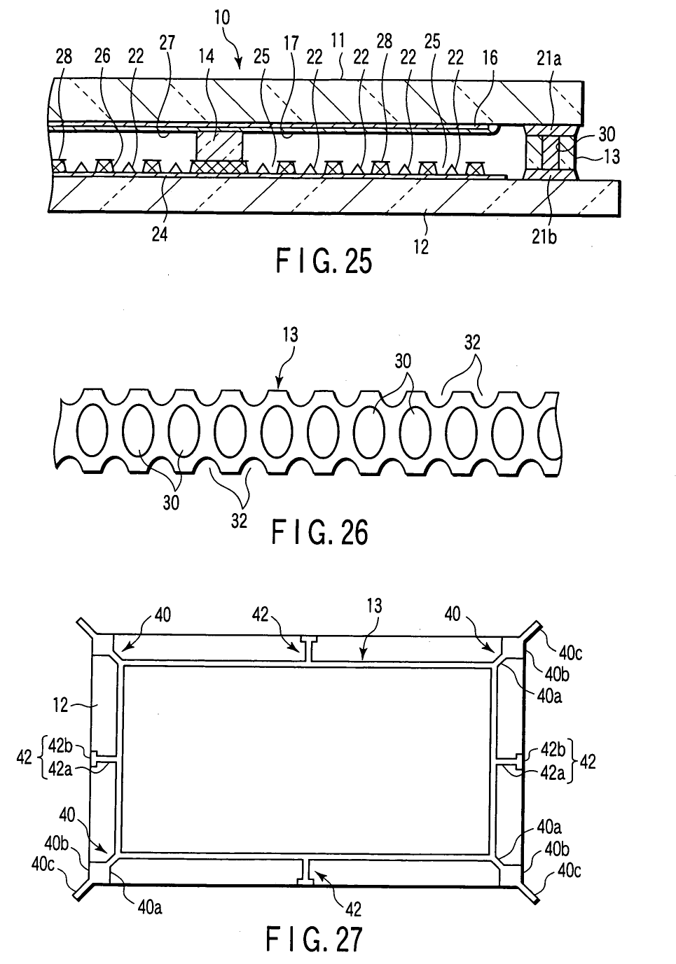

As shown in FIGS. 24, 25 and 26, the frame body 13 has a large number of through holes 30 arranged like meshes of a net and a plurality of slits 32 that open in side faces of the frame body, as a structure that eases the elasticity along the longitudinal direction of each side portion. The through holes 30 and the slits 32 are formed individually penetrating the front substrate 11 and the rear substrate 12 at right angles to their surfaces, and are arranged at given spaces throughout the circumference of the frame body 13. Preferably, the frame body 13 is formed of a material that has a melting point of 500° C. or more, and a material that contains at least one of elements including Ti, Fe, Cr, Ni, Al and Cu may be used for it. The width of each side portion of the frame body 13 is adjusted to 4 mm or less, and preferably, to 2 to 3 mm.

As shown in FIGS. 24 and 25, the vacuum envelope 10 has therein a plurality of plate-like spacers 14, which serve to bear an atmospheric load that acts on the front substrate 11 and the rear substrate 12. These spacers 14 are arranged parallel to the short sides of the vacuum envelope 10 and spaced in a direction parallel to the long sides. The spacers 14 are not restricted particularly to this shape, and columnar spacers or the like may be used alternatively, for example. Formed on the inner surface of the front substrate 11, as in the first embodiment, are a phosphor screen 16, which has phosphor layers R, G and B that glow red, green, and blue, respectively, and a matrix-shaped black light absorbing layer, a metal back 17 formed of aluminum or the like, and moreover, a getter film 27, which are successively arranged overlapping one another.

Provided on the inner surface of the rear substrate 12, as shown in FIG. 25, are a large number of electron emitting elements 22 for use as electron emission sources that individually run electrons against the phosphor layers R, G and B to excite them. The electron emitting elements 22 are located in positions opposite the individual phosphor layers R, G and B and emit electron beams toward their corresponding phosphor layers. Further, a large number of wires 19 that drive the electron emitting elements 22 are formed in a matrix on the inner surface of the rear substrate 12. The respective end portions of the wires 19 are drawn out onto the peripheral edge portion of the rear substrate.

The following is a description of a manufacturing method and a manufacturing apparatus for the FED constructed in this manner.

First, the front substrate 11 is prepared having the phosphor screen 16 formed on its inner surface, and indium as the sealing material 21a is spread in the shape of a frame on a joint surface situated on the inner surface of the front substrate and outside the phosphor screen. The rear substrate 12 is prepared having a large number of electron emitting elements 22 formed on its inner surface, and the spacers 14 are fixed to it. Indium as the sealing material 21b is spread in the shape of a frame on a joint surface situated on the inner surface of the rear substrate 12 and at an outside peripheral edge portion of the electron emitting elements 22.

Subsequently, the electrically conductive frame body 13 is located overlapping the sealing material 21b, as shown in FIG. 27. The projections 40 that serve as electrodes through which current for conductive heating flows are integrally formed in advance at four corners of the frame body 13, and the positioning projections 42 are integrally formed in advance on the respective central portions of the individual sides. After the frame body 13 is aligned with the rear substrate 12, the projections 40 and 42 are tacked to the rear substrate 12. A suitable bonding material or fixing member is properly selected and used for the tacking. For ease of current supply, moreover, each projection 40 is formed integrally with a lug 40c that protrudes further outward from the fixed portion 40.

In this case, the front substrate 11 and the rear substrate 12 are loaded with the sealing material. Alternatively, however, the frame body 13 may be loaded with the sealing material, or the front substrate 11, rear substrate 12, and frame body 13 may be loaded individually.

Then, the front substrate 11 and the rear substrate 12, having the frame body 13 placed on the sealing material 21b, are opposed to each other at a given distance as they are held by a jig or the like with their respective joint surfaces facing each other. When this is done, the rear substrate 12 is located under the front substrate 11 with its face upward, for example. In this state, the front substrate 11 and the rear substrate 12 are put into a vacuum processor. As in the first embodiment, the vacuum processor 100 shown in FIG. 6 is used as this vacuum processor.

First, the front substrate 11 and the rear substrate 12 are put into the loading chamber 101, and are delivered to the baking and electron beam cleaning chamber 102 after a vacuum atmosphere is formed in the loading chamber 101. In the baking and electron beam cleaning chamber 102, the front substrate 11 and the rear substrate 12 are fully degassed by heating when a high degree of vacuum of about 10⁻⁵ Pa is attained. The heating temperature is set to about 200 to 500° C. as required. This is done in order to reduce the speed of gas discharge from the inner wall of the resulting vacuum envelope that lowers the degree of vacuum, thereby preventing properties from being degraded by residual gas.

The moment the members are heated in the baking and electron beam cleaning chamber 102, the electron beam generator (not shown) that is attached to the baking and electron beam cleaning chamber 102 applies an electron beam to the phosphor screen surface of the front substrate 11 and the electron emitting element surface of the rear substrate 12. Since this electron beam is deflected for scanning by the deflector that is mounted on the outside of the electron beam generator, the phosphor screen surface and the electron emitting element surface can be entirely cleaned with the electron beam.

After the heating and electron beam cleaning, the front substrate 11 and the rear substrate 12 are delivered to the cooling chamber 103 and cooled to a temperature of about 100° C., for example. Subsequently, the front substrate 11 and the rear substrate 12 are delivered to the vapor deposition chamber 104 for getter film, whereupon a barium film is formed as the getter film on the phosphor screen and the metal back by vapor deposition. This barium film can prevent the surface from being soiled by oxygen or carbon, thereby maintaining an active state.

Then, in the assembly chamber 105, the front substrate 11 and the rear substrate 12 are highly accurately positioned and lapped on each other so that the phosphor screen 16 face the electron emitting elements 22. When this is done, the frame body 13 is sandwiched between the sealing material 21a on the peripheral edge portion of the front substrate 11 and the sealing material 21b on the peripheral edge portion of the rear substrate 12.

In this state, the projections 40 that protrude individually from the four corners of the frame body 13 are brought into contact with device-side electrodes. A given current is supplied to the frame body 13 and the sealing materials 21a and 21b through the lugs 40c of the projections 40 so that the sealing materials are heated to be melted, and the front substrate 11 and the rear substrate 12 are pressurized in a direction to approach each other. In this heating by current supply, only the frame body 13 and the sealing materials 21a and 21b are mainly heated, so that the heating can be achieved in a short time, and extra thermal expansion of the front substrate 11 or the rear substrate 12 cannot easily occur. If the current supply is stopped, thereafter, heat from the frame body 13 and the sealing materials 21a and 21b thermally diffuses into the front substrate 11 or the rear substrate 12. Thus, the sealing materials are cooled and solidified to complete the sealing in a short time.

After the vacuum envelope 10 formed in this manner is cooled to normal temperature in the cooling chamber 106, it is taken out through the unloading chamber 107. After the vacuum envelope 10 is assembled, the lugs 40c of the projections 40 are removed. If the projections 40 and 42 are obstructive to the product, moreover, they should only be removed by suitable means. The FED is completed in these processes.

According to the FED constructed in this manner and the method of manufacturing the same, the use of the electrically conductive frame body 13 enables the front substrate 11 and the rear substrate 12 to be joined with each other by supplying current to the frame body to melt or soften the sealing materials 21a and 21b. If the abundance of the sealing materials is partially distributed or if the sealing materials melt during current supply, therefore, the electrically conductive frame body 13 can ease or reduce the possibility of uneven heating or disconnection. Further, the frame body 13 can be fixed to the front substrate 11 and the rear substrate 12 by the projections 40 and 42 that protrude from the four corners and the individual side portions. Thus, if the frame body is thermally expanded by current supply, the frame body can be prevented from being distorted or twisted, and the frame body can be kept in a predetermined position relative to the substrates.

If the frame body 13 used is supposed to have no projections on the side portions, the frame body 13 itself is heated and undergoes elongation that is attributable to thermal expansion when current for melting the sealing materials is supplied to the frame body 13. Therefore, the individual side portions are twisted. Although such distortion of the side portions can be restrained by forming the frame body 13 wider, the width of the frame body 13 must be increased to 4 mm or more, practically. If the width of the frame body 13 is increased to 4 mm or more, however, its cross section is so large that its resistance lowers. In consequence, a current value for satisfactory Joule heat is inevitably too large to be feasible.

In the FED according to the present embodiment described above, on the other hand, the projections 42 are provided individually on the side portions of the frame body 13 as well as on the four corners, and the frame body is positioned with respect to the rear substrate 12 with those projections. If the frame body 13 is a slim one having a width of 4 mm or less, therefore, its side portions can be restrained from being distorted or twisted during conductive heating, and it can be accurately sealed in a predetermined position.

According to the third embodiment, moreover, the frame body 13 has the mesh-like through holes 30 and the slits 32. Therefore, the resistance of the frame body 13 can be made higher than that of a frame body that is provided with neither the through holes 30 nor the slits 32. Thus, the frame body 13 need not be restricted to a narrow width lest its resistance be too low, so that the frame width can be increased to improve the sealing reliability. At the same time, a current that is required by the conductive heating through the frame body for sealing can be reduced, so that thermal expansion of the heated frame body can be restrained.

The frame body 13, compared with the one that is provided with neither the through holes 30 nor the slits 32, is flexible, having great elasticity along the longitudinal direction of each side, that is, in a direction parallel to the surfaces of the substrates. Thus, the problem of the frame body 13 being thermally expanded and twisted by the conductive heating can be solved more securely. For a thermal change, such as a change of ambient temperature or the like, at the same time, an effect to ease the stress of the frame body 13 can be obtained, so the sealing reliability is improved. If the sealing materials 21a and 21b are melted, moreover, the retention of the indium can be improved, so that the indium can be prevented from flowing out or being partially distributed. Thus, the frame body 13 can be sealed uniformly throughout its circumference.

In the manner described above, the sealing operation for the front substrate and the rear substrate can be carried out quickly and steadily, and the FED having a satisfactory degree of vacuum can be obtained.

The following is a description of a plurality of examples to which the present invention is applied.

### EXAMPLE 6

The following is a description of an example in which the configuration shown in FIGS. 23 to 25 is applied to an FED display device for a 30-inch TV. Its principal configuration is the same as the one described in connection with the foregoing embodiment.

A front substrate 11 and a rear substrate 12 are formed of a glass plate of 2.8-mm thickness each. Indiums of 0.2-mm thickness and 3-mm width each, for use as sealing materials 21a and 21b, are arranged individually on the respective peripheral edge portions of the front substrate 11 and the rear substrate 12.

As shown in FIGS. 24 and 25, a frame body 13 is a nickel alloy of 3-mm width and 2-mm thickness that is bored with through holes 30 having elliptic diameters of φ2 to 3 mm and arranged like meshes of a net and slits 32 having a substantially semicircular cross section. The frame body 13 has projections 40 and 42 at its four corners and the respective centers of its sides. The frame body 13 is positioned so as to overlap the sealing material 21b on the peripheral edge portion of the rear substrate 12, and is fixed to the peripheral edge portion of the rear substrate 12 by fixed portions 40b and 42b.

The front substrate 11 and the rear substrate 12 were put into a vacuum tank and degassed in the vacuum tank so that the getter film was formed. When the substrate temperature attained 120° C., thereafter, the front substrate 11 and the rear substrate 12 were aligned with predetermined positions so that the frame body 13 was sandwiched between the sealing materials 21a and 21b, and the front substrate and the rear substrate were pressurized under a load of about 20 kgf.

In this state, 360 A was supplied to the projections 40 of the frame body 13 for 30 seconds. As this is done, the sealing materials 21a and 21b were heated to about 160° C. and melted. When the current supply was completed, heat from the frame body 13 and the indium quickly thermally diffused into the substrates and the like, whereupon the indium was cooled and solidified. An FED was obtained by taking out the front substrate 11 and the rear substrate 12 in about 300 seconds thereafter.

By thus fixing the frame body 13 with use of the projections 40 and 42, distortion and twist of each side portion were able to be fully restrained even though the width of the frame body 13 was 3 mm.

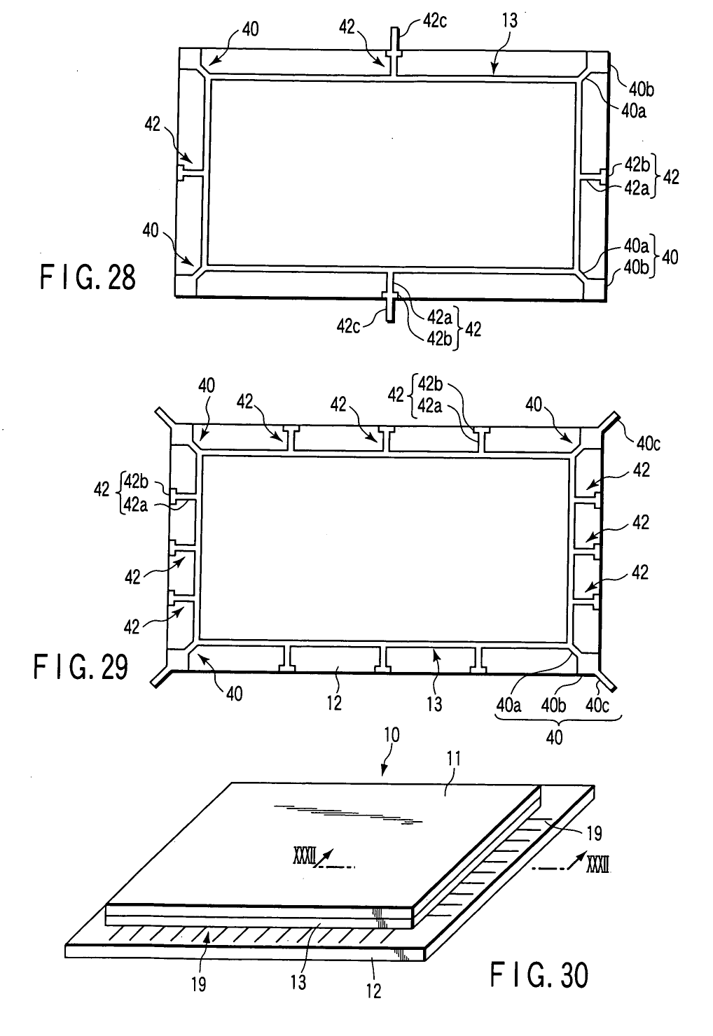

In the present embodiment, the projections 40 at the four corners of the frame body 13 were utilized as current supply electrodes. Alternatively, however, the projections 42 on the side portions of the frame body may be provided with lugs 42c to be used as current supply electrodes, as shown in FIG. 28.

### EXAMPLE 7

In Example 7, as shown in FIG. 29, each side portion of a frame body 13 formed of a φ2 nickel alloy wire was provided with a plurality of projections 42. If the frame body 13 is a fragile one such as a wire, in a large-sized FED of about 30 inches, it is hard satisfactorily to remedy distortion of projections that are located only on the respective centers of the sides of the frame body. As in Example 7, therefore, the distortion of the frame body can be remedied by arranging a large number of projections 42 on the individual sides of the frame body 13.

### EXAMPLE 8

In Example 3, as in Example 3 shown in FIG. 20, a frame body 13 was provided with a large number of straight slits 32 as a structure that eases the elasticity along the longitudinal direction of each side portion, and the frame body 13 was formed substantially in the shape of a bellows as a whole. The slits 32 are formed at right angles to the respective surfaces of the front substrate and the rear substrate, and are formed extending alternately from the opposite side faces of the frame body 13. Also with use of these slits 32, as in the case where the frame body is provided with the through holes 30, the frame body 13 can be made elastic against thermal expansion, whereby distortion and twist can be restrained. The projections on the side portions of the frame body cannot primarily restrain thermal expansion and replace the distortion into a local undulation. However, the aforesaid elastic structure can absorb the thermal expansion itself.

For other configurations, this example resembles the aforesaid embodiment.

### EXAMPLE 9

In Example 9, as in Example 5 shown in FIG. 22, each side portion of a frame body 13 is bent substantially in the shape of a bellows. In this case, the cross section of each side portion may be rectangular, circular, or of any other shape. Also with use of this bent structure, the same effects of the other examples were able to be obtained. For other configurations, this example resembles the aforesaid embodiment.

The following is a detailed description of an FED according to a fourth embodiment of this invention.

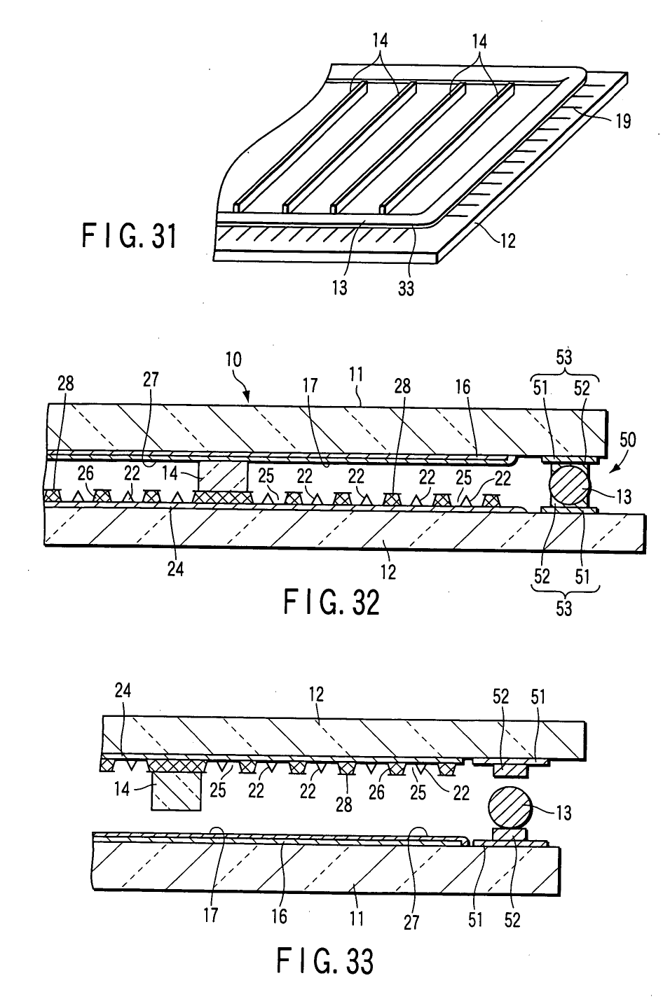

As shown in FIGS. 30 to 32, this FED comprises a front substrate 11 and a rear substrate 12, which are formed of a rectangular glass as an insulating substrate each and are opposed to each other with a gap of 1 to 2 mm between them. The front substrate 11 and the rear substrate 12 have their respective peripheral edge portions joined together by a rectangular frame body 13, and constitute a flat, rectangular vacuum envelope 10, which is internally kept in a vacuum state.

The respective peripheral edge portions of the front substrate 11 and the rear substrate 12 are joined together with a sealing portion 50. More specifically, the rectangular frame body 13 is located between a sealed surface that is situated on the peripheral edge portion of the inner surface of the front substrate 11 and a sealed surface that is situated on the peripheral edge portion of the inner surface of the rear substrate 12. The front substrate 11 and the rear substrate 12 are sealed individually to the frame body 13 with sealing layers 53 in which ground layers 51 formed on the respective sealed surfaces of the substrates and indium layers 52 formed on the ground layers are fused together. These sealing layers 53 and the frame body 13 constitute the sealing portion 50.

In the present embodiment, the sectional shape of the frame body 13 is circular. This sectional shape is the shape of a cross section perpendicular to a major axis of the frame body 13. A space between the sealed surface of the front substrate 11 and the outer surface of the frame body 13 and a space between the sealed surface of the rear substrate 12 and the outer surface of the frame body 13 vary in the width direction of the frame body. More specifically, if the frame body 13 is formed having a circular section, these spaces are narrow in the central portion with respect to the width direction of the frame body and are gradually widened toward the opposite sides. The indium layers 52 fill the spaces between the sealed surface of the front substrate 11 and the outer surface of the frame body 13. In this case, the width of each indium layer 52 is restricted within the range of the maximum width of the frame body 13.

The vacuum envelope 10 has therein a plurality of plate-like spacers 14, which serve to bear an atmospheric load that acts on the rear substrate 12 and the front substrate 11. These spacers 14 extend parallel to the short sides of the vacuum envelope 10 and are spaced in a direction parallel to the long sides. The spacers 14 are not restricted particularly to this shape, and columnar spacers may be used alternatively.

As in the first embodiment, a phosphor screen 16, which has phosphor layers R, G and B that glow red, blue, and green, respectively, and a black light absorbing layer, a metal back 17, and a getter film 27 are successively formed overlapping one another on the inner surface of the front substrate 11.

Provided on the inner surface of the rear substrate 12 are a large number of field-emission electron emitting elements 22 for use as electron emission sources that individually excite the phosphor layers R, G and B. These electron emitting elements 22 are arranged in a plurality of columns and a plurality of rows corresponding to pixels, individually. A large number of wires 19 that supply driving signals to the electron emitting elements 22 are formed in a matrix on the inner surface of the rear substrate 12. The respective end portions of the wires 19 are drawn out onto the peripheral edge portion of the rear substrate.

The following is a detailed description of a manufacturing method for the FED constructed in this manner.

The front substrate 11 having the phosphor screen 16 on its inner surface and the rear substrate 12 having the large number of electron emitting elements 22 on its inner surface are prepared by the same processes of the foregoing first embodiment. Then, the spacers 14 are fixed to the rear substrate 12. Since high voltage is applied to the phosphor screen 16, high strain-point glass is used for the front substrate 11, rear substrate 12, and spacers 14.

Subsequently, the frame body 13 to be located on the peripheral edge portions of the substrates is formed. The frame body 13 is formed of a metallic round rod or wire having a circular cross section, it is bent into a rectangular frame depending on a necessary size. The metal used may be a simple substance including any of materials including Fe, Ni and Ti, for example, or an electrically conductive metal such as an alloy, or an electrically nonconductive material such as glass, ceramics, etc. Fe was used in this case.

The frame body is bent in three positions corresponding to its three corner portions. That part of the frame body 13 which corresponds to the remaining one corner portion is formed by welding together the opposite ends of the wire by means of a laser welder. In doing this, the frame body is fabricated by instantaneously fusing only the welded joints by the laser welder. Preferably, in the welding operation, irregularities should not be left on the junction. If the frame body is subject to irregularities, it is flattened with a gold file or the like so that it can be fully utilized as an entire one.

Then, silver paste is spread on the sealed surface that is situated on the peripheral edge portion of the inner surface of the front substrate 11 and the sealed surface that is situated on the peripheral edge portion of the inner surface of the rear substrate 12, whereupon the frame-shaped ground layers 51 are formed. Subsequently, indium as an electrically conductive metallic sealing material is spread on each ground layer 51, thereby forming the indium layers 52 that extend individually throughout the ground layers.

Preferably, the metallic sealing material should be a low-melting-point metal material that has a melting point of about 350° C. and high adhesion and bondability. The indium (In) used in the present embodiment has outstanding features, such as low vapor pressure, softness to resist impact, reluctance to low-temperature brittleness, etc., as well as a low melting point of 156.7° C. This is a suitable material, moreover, since it can be joined directly to glass, depending on conditions.

Then, the rear substrate 12 having the ground layer 51 and the indium layer 52 on its sealed surface and the front substrate 11 having the frame body 13 placed on its indium layer 52 are held by a jig or the like with their respective sealed surfaces facing each other and opposed at a given distance, as shown in FIG. 33. When this is done, the front substrate 11 is located under the rear substrate 12 with its face upward, for example. In this state, the front substrate 11 and the rear substrate 12 are put into a vacuum processor. As in the first embodiment, the vacuum processor 100 shown in FIG. 6 is used as this vacuum processor.

The front substrate 11 and the rear substrate 12 on which the frame body 13 is placed are put into the loading chamber 101, and are delivered to the baking and electron beam cleaning chamber 102 after a vacuum atmosphere is formed in the loading chamber 101. In the baking and electron beam cleaning chamber 102, the rear substrate 12 and the front substrate 11 are heated to a temperature of about 300° C. to be baked, whereby a gas adsorbed by the respective surfaces of these members is released.

The indium layers (melting point: about 156° C.) 52 melt at this temperature. Since the indium layers 52 are formed on the highly affinitive ground layers 51, however, the indium is held on the ground layers when it flows. The frame body 13 and the front substrate 11 are joined together with the melted indium. The front substrate 11 to which the frame body 13 is joined will hereinafter be referred to as a front-substrate-side assembly.

The moment the members are heated in the baking and electron beam cleaning chamber 102, the electron beam generator (not shown) that is attached to the baking and electron beam cleaning chamber 102 applies an electron beam to the phosphor screen surface of the front-substrate-side assembly and the electron emitting element surface of the rear substrate 12. Since this electron beam is deflected for scanning by the deflector that is mounted on the outside of the electron beam generator, the phosphor screen surface and the electron emitting element surface can be entirely cleaned with the electron beam.

After the heating and electron beam cleaning, the front-substrate-side assembly and the rear substrate 12 are delivered to the cooling chamber 103 and cooled to a temperature of about 100° C., for example. Subsequently, the front-substrate-side assembly and the rear substrate 12 are delivered to the vapor deposition chamber 104 for getter film, whereupon a barium film is formed as the getter film on the phosphor screen and the metal back by vapor deposition. This barium film can prevent the surface from being soiled by oxygen or carbon, thereby maintaining an active state.

Then, the front-substrate-side assembly and the rear substrate 12 are delivered to the assembly chamber 105, in which they are heated to 200° C. Thereupon, the indium layers 52 melt again into a liquid phase or soften. In this state, the frame body 13 and the rear substrate 12 are joined together with the indium layers 52 between them and are pressurized under a given pressure in a direction to approach each other. As this is done, some of the pressurized melted indium is urged to flow toward a display region or wiring region of the rear substrate 12. Since the frame body 13 has a circular cross section, however, the melted indium stays in a wide space between the sealed surface of the rear substrate 12 and the outer surface of the frame body, and is prevented from flowing beyond the width of the frame body toward the display region or outward. Thus, the indium can be kept within the range of the maximum width of the cross section of the frame body 13 on both the side of the front substrate 11 and the side of the rear substrate 12.

Thereafter, the indium is slowly cooled and solidified. Thereupon, the rear substrate 12 and the frame body 13 are sealed together with the sealing layers 53 in which the indium layers 52 and the ground layers 51 are fused together. At the same time, the front substrate 11 and the frame body 13 are sealed together with the sealing layers 53 in which the indium layers 52 and the ground layers 51 are fused together, whereupon the vacuum envelope 10 is formed.

After the vacuum envelope 10 formed in this manner is cooled to normal temperature in the cooling chamber 106, it is taken out through the unloading chamber 107. The FED is completed in these processes.

According to the FED constructed in this manner and the method of manufacturing the FED, the surface-adsorbed gas can be thoroughly released from the substrates by a combination of baking and electron beam cleaning with the front substrate 11 and the rear substrate 12 sealed in the vacuum atmosphere. Therefore, a satisfactory gas adsorption effect can be obtained without causing the getter film to be oxidized. Thus, the resulting FED can maintain a high degree of vacuum.

When the front substrate 11 and the rear substrate 12 to be sealed are joined together and pressurized under a given pressure, the melted sealing material flows in wide regions between the outer surface of the frame body and the sealed surfaces of the substrates. Thus, secure sealing can be performed without causing the melted sealing material to overflow into the image display region or wiring region or without causing any trouble, such as a wiring short. At the same time, it is unnecessary to secure a large sealing width in consideration of the overflow of the sealing material, so that a narrow-frame FED can be obtained. According to the configuration described above, moreover, even a large-sized image display device of 50 inches or more can be sealed easily and securely, and high mass-producibility can be enjoyed.

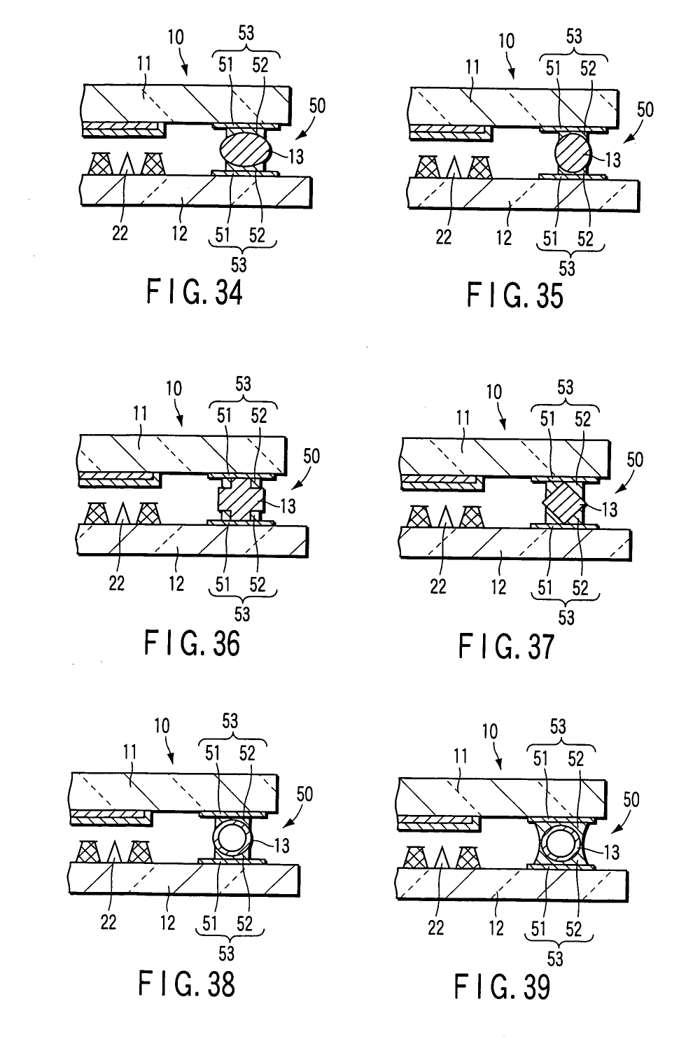

In the fourth embodiment described above, the sectional shape of the frame body 13 is circular. Alternatively, however, the sectional shape must only be such that the space between the outer surface of the frame body and the sealed surface of the front substrate and/or the rear substrate varies in the width direction of the frame body. Further, the frame body should only be formed having a sectional shape such that it at least partially has a surface that faces the sealed surface of the front substrate and/or the rear substrate in unparallel relation, that is, a surface that is not parallel to the sealed surface. As shown in FIGS. 34, 35, 36 and 37, for example, the frame body 13 may have an elliptic, cruciform, or rhombic sectional shape.

The frame body 13 is not limited to a solid one, and may be formed having a hollow structure, as shown in FIG. 38. Also in this case, the sectional shape of the frame body 13 need not always be circular, and may alternatively be elliptic, cruciform, or rhombic, as in the examples shown in FIGS. 34, 35, 36 and 37.

As shown in FIG. 39, moreover, the sealing layer 53 between the frame body 13 and the front substrate 11 and the sealing layer 53 between the frame body 13 and the rear substrate 12 may be linked together around the frame body so that the frame body 13 is embedded in the sealing layers 53.

The frame body 13 is not limited to metal in material, but may be formed of any other material, such as glass or ceramics, provided that it has the shape of a frame based on the foregoing embodiment.

Further, the sealing material is not limited to indium, but the sealing material used may be one that reduces the difference in thermal expansion coefficient between a glass panel and the sealing material or lessen the influence of thermal expansion in sealing the glass panel. For example, an alloy that contains In and/or Ga may be used as an electrically conductive sealing material. Fritted glass, an organic bonding material, or an inorganic bonding material may be used as an electrically nonconductive sealing material.

In the fourth embodiment described above, moreover, the indium or other sealing material is used to seal the spaces between the frame body and the front substrate and between the frame body and the rear substrate in the vacuum atmosphere during the manufacture of the vacuum envelope. Alternatively, however, a remaining joint may be joined in the vacuum atmosphere by the aforementioned processes after the space between the frame body and the front substrate or between the frame body and the rear substrate is previously sealed with indium or other sealing material or low-melting-point glass in the air.

In joining the front substrate and the rear substrate together, in the fourth embodiment, furthermore, these substrates are heated to about 200° C. to melt or soften the indium layers in the assembly chamber. Instead of heating the entire substrates, however, the indium layers may be melted or softened by conductive heating. More specifically, the front substrate and the rear substrate are pressurized in a direction to approach each other so that the frame body is sandwiched between the indium layers. In this state, the frame body 13 may be energized to generate Joule heat so that the indium layers 52 can be melted by this heat to seal the substrates. In this case, the frame body 13 is formed of an electrically conductive material. If the frame body 13 is formed having a hollow structure, as shown in FIG. 38, in this case, it can be configured to have high resistance and be easily heated, so that the conduction current can be reduced. At the same time, the heat capacity of the frame body 13 is so small that the frame body can be cooled in a short time after the front substrate and the rear substrate are sealed together. In consequence, the manufacturing efficiency can be improved.

Alternatively, the indium layers 52, not the frame body 13, may be directly energized so that the indium layers 52 can be melted or softened by Joule heat to seal the substrates.

The present invention is limited to the embodiments described above, and in carrying out the invention, various modifications may be made without departing from the scope of the invention when it is practiced. Further, the foregoing embodiments include inventions of various stages, and various inventions can be extracted by appropriately combining a plurality of disclosed required constituent elements. Even when some required constituent elements are omitted from all required constituent elements described in the embodiments, for example, an arrangement from which the required constituent elements are omitted can be extracted as an invention as long as the problems that have been discussed in the paragraphs of the problem to be solved by the invention can be solved, and the effects that have been explained in the paragraphs of the effect of the invention can be obtained.

For example, the shape of the vacuum envelope, configuration of the support members, shape of the phosphor screen, type of the sealing materials, etc. can be variously selected as required without being limited to the foregoing embodiments. In the aforementioned embodiments, moreover, the field-emission electron emitting elements are used as the electron emitting elements. However, they may be replaced with any other electron emitting elements, such as pn-type cold cathode elements or surface-conduction electron emitting elements. Further, the present invention is not limited to an FED, SED, or other display devices that require a vacuum envelope. Alternatively, the invention may be effectively applied to a PDP or any other image display device that is configured to be injected with discharge gas after it is evacuated once.

According to this the present invention, as described herein, there may be provided an image display device, capable of being securely joined in a short time without failing steadily to maintain a frame shape, and a method of manufacturing the same.

In sealing together the respective peripheral edge portions of the front substrate and the rear substrate by conductive heating with the electrically conductive frame body between them, according to this invention, the necessary current for the conductive heating can be reduced, so that thermal expansion of the heated frame body can be restrained. Thus, sealing operation for the front substrate and the rear substrate can be performed quickly and steadily, and there may be provided the image display device having a satisfactory degree of vacuum and the method of manufacturing the image display device.

In sealing together the respective peripheral edge portions of the front substrate and the rear substrate by conductive heating with the electrically conductive frame body between them, according to this invention, distortion and twist of the electrically heated frame body can be restrained. Thus, sealing operation for the front substrate and the rear substrate can be performed quickly and steadily, and there may be provided the image display device having a satisfactory degree of vacuum and the method of manufacturing the image display device.

According to this invention, there may be provided the image display device, capable of enjoying a narrow-frame design and steady maintenance of air-tightness, and the method of manufacturing the image display device.

1. An image display device comprising:
an envelope having a front substrate and a rear substrate opposed to each other and a rectangular frame body provided between respective peripheral portions of the front substrate and the rear substrate; and
a plurality of pixels formed in the envelope,
the frame body having projections which protrude outward in a direction parallel to sides of the frame body from individual corner portions and are configured to be nipped.

2. The image display device according to claim 1, wherein each of the projections protrudes outward in a direction parallel to long sides of the frame body from each corner portion of the frame body.

3. The image display device according to claim 1, wherein each of the projections protrudes outward in a direction parallel to short sides of the frame body from each corner portion of the frame body.

4. The image display device according to claim 1, wherein the frame body is joined to at least one of the rear substrate and the front substrate with a low-melting-point metal.

5. A method of manufacturing an image display device, which comprises an envelope having a front substrate and a rear substrate opposed to each other and a frame body in the form of a rectangular frame provided between respective peripheral portions of the front substrate and the rear substrate and a plurality of pixels formed in the envelope, the method comprising:
preparing the frame body in the form of a rectangular frame having projections which protrude outward from individual corners;
nipping and pulling the projections of the frame body outward, thereby applying a tension to each side portion of the frame body in the longitudinal direction thereof;
positioning and joining the frame body to at least one of the front substrate and the rear substrate with the tension kept applied.

6. The method of manufacturing an image display device according to claim 5, wherein the frame body is prepared having projections which extend in the directions of diagonal axes from the individual corner portions, and the projections are nipped and pulled outward in the directions of the diagonal axes to apply the tension to each side portion of the frame body.

7. The method of manufacturing an image display device according to claim 5, wherein the frame body is prepared having projections which extend in a direction parallel to sides from the individual corner portions, and the projections are nipped and pulled outward to apply the tension to each side portion of the frame body.

8. The method of manufacturing an image display device according to claim 5, wherein the frame body is positioned and joined in a vacuum atmosphere.

9. An image display device comprising:
an envelope having a front substrate, a rear substrate opposed to the front substrate, an electrically conductive frame body located between respective peripheral portions of the front substrate and the rear substrate so as to join the front substrate and the rear substrate together, and a sealing material located between the frame body and the front substrate or the rear substrate,
the frame body having a plurality of through holes or slits formed penetrating the frame body in a direction perpendicular to the surface of the front substrate.

10. The image display device according to claim 9, wherein the through holes or slits are formed with different densities depending on the place throughout the circumference of the frame body.

11. The image display device according to claim 9, wherein the through holes or slits are arranged in the shape of a bellows.

12. The image display device according to claim 9, wherein the through holes or slits are arranged like meshes of a net.

13. The image display device according to claim 9, wherein the sealing material contains In or an indium-based alloy.

14. The image display device according to claim 9, wherein the sealing material is a material which melts or soften at 300° C. or less.

15. The image display device according to claim 9, wherein the frame body is formed of a material which contains at least one of elements including Ti, Fe, Cr, Ni, Al and Cu.

16. The image display device according to claim 9, wherein the frame body is formed of a material having a melting point of 500° C. or more.

17. The image display device according to claim 9, wherein the envelope has therein a phosphor and an electron source which excites the phosphor, and the envelope is internally kept under a vacuum.

18. A method of manufacturing an image display device, which comprises an envelope having a front substrate, a rear substrate opposed to the front substrate, an electrically conductive frame body located between respective peripheral portions of the front substrate and the rear substrate so as to join the front substrate and the rear substrate together, and a sealing material located between the frame body and the front substrate or the rear substrate, the method comprising:
preparing the frame body having a plurality of through holes or slits formed penetrating the frame body in a direction perpendicular to the surface of the front substrate;
arranging the front substrate and the rear substrate opposite to each other;
arranging the frame body between peripheral edge portions of the respective inner surfaces of the front substrate and the rear substrate and along the respective peripheral edge portions of the front substrate and the rear substrate and arranging an electrically conductive sealing material between the frame body and at least one of the peripheral edge portions of the respective inner surfaces of the front substrate and the rear substrate so as to cover the whole circumference; and
heating the frame body by supplying current thereto, thereby melting or softening the sealing material, pressurizing the front substrate and the rear substrate toward each other, and sealing the respective peripheral edge portions of the front substrate and the rear substrate.

19. The method manufacturing an image display device according to claim 18, wherein the frame body is supplied with current to melt or soften the sealing material in a vacuum atmosphere.

20. An image display device comprising:
an envelope having a front substrate, a rear substrate opposed to the front substrate, an electrically conductive frame body located between respective peripheral portions of the front substrate and the rear substrate so as to join the front substrate and the rear substrate together, and a sealing material located between the frame body and the front substrate or the rear substrate,
the frame body having four projections which protrude outward from four corners and at least one projection which protrudes outward from a side portion.

21. The image display device according to claim 20, wherein the width of at least a part of the frame body is 4 mm or less.

22. The image display device according to claim 20, wherein each side portion of the frame body has a structure such that elasticity in the longitudinal direction thereof is eased.

23. The image display device according to claim 22, wherein the frame body has a plurality of through holes or slits penetrating the frame body in a direction perpendicular to the surface of the front substrate.

24. The image display device according to claim 20, wherein each side portion of the frame body has at least one projection which protrudes outward.

25. The image display device according to claim 20, wherein each side portion of the frame body has a plurality of projections which protrude outward.

26. The image display device according to claim 20, wherein each of the projections has an elongated stem portion which protrudes from a corner or side portion of the frame body and a fixed portion which is formed on an extended end of the stem portion and is wider than the stem portion, and is joined to the front substrate and the rear substrate.

27. The image display device according to claim 20, wherein the sealing material contains In or an indium-based alloy.

28. The image display device according to claim 20, wherein the sealing material is a material which melts or soften at 300° C. or less.

29. The image display device according to claim 20, wherein the frame body is formed of a material which contains at least one of elements including Ti, Fe, Cr, Ni, Al and Cu.

30. The image display device according to claim 20, wherein the frame body is formed of a material having a melting point of 500° C. or more.

31. The image display device according to claim 20, wherein the envelope has therein a phosphor and an electron source which excites the phosphor, and the envelope is internally kept under a vacuum.

32. A method of manufacturing an image display device, which comprises an envelope having a front substrate, a rear substrate opposed to the front substrate, an electrically conductive frame body located between respective peripheral portions of the front substrate and the rear substrate so as to join the front substrate and the rear substrate together, and a sealing material located between the frame body and the front substrate or the rear substrate, the method comprising:
preparing the frame body having four projections which protrude outward from four corners and at least one projection which protrudes outward from a side portion;
arranging the front substrate and the rear substrate opposite to each other;
arranging the frame body between peripheral edge portions of the respective inner surfaces of the front substrate and the rear substrate and along the respective peripheral edge portions of the front substrate and the rear substrate and arranging an electrically conductive sealing material between the frame body and at least one of the peripheral edge portions of the respective inner surfaces of the front substrate and the rear substrate so as to cover the whole circumference;
tacking the projections of the frame body to at least one of the peripheral edge portions of the respective inner surfaces of the front substrate and the rear substrate, thereby positioning the frame body in a predetermined position;
heating the frame body by current supply after positioning the frame body, thereby melting or softening the sealing material, pressurizing the front substrate and the rear substrate toward each other, and sealing the respective peripheral edge portions of the front substrate and the rear substrate.

33. The method of manufacturing an image display device according to claim 32, wherein extra projections of the frame body are removed after the respective peripheral edge portions of the front substrate and the rear substrate are sealed together.

34. The manufacturing method for an image display device according to claim 32, wherein the frame body is supplied with current to melt or soften the sealing material in a vacuum atmosphere.

35. An image display device comprising:
an envelope having a front substrate and a rear substrate opposed to each other and a sealing portion which seals respective peripheral edge portions of the front substrate and the rear substrate together,
the sealing portion including a frame body and a sealing material which extend along the respective peripheral edge portions of the front substrate and the rear substrate, the frame body having a sectional shape such that a space between the outer surface of the frame body and the inner surface of at least one of the front substrate and the rear substrate varies in the width direction of the frame body, the sealing material being provided between the frame body and the inner surface of at least one of the substrates.

36. The image display device according to claim 35, wherein the frame body has a circular or elliptic sectional shape.

37. The image display device according to claim 35, wherein the frame body has a rhombic sectional shape.

38. The image display device according to claim 35, wherein the frame body has a cruciform sectional shape.

39. The image display device according to claim 35, wherein the frame body is formed having a sectional shape at least partially including a surface which faces the inner surface of the at least one substrate in unparallel relation.

40. The image display device according to claim 35, wherein the frame body is hollow.

41. The image display device according to claim 35, wherein the frame body is solid.

42. The image display device according to claim 35, wherein the sealing materials are provided individually between the frame body and the front substrate and between the frame body and the rear substrate.

43. The image display device according to claim 35, wherein the sealing material is provided within the range of a maximum width of a cross section of the frame body.

44. The image display device according to claim 35, wherein the sealing material covers the whole outer surface of the frame body.

45. The image display device according to claim 35, wherein the sealing material is a low-melting-point metal.

46. The image display device according to claim 35, wherein the sealing material has electrical conductivity.

47. The image display device according to claim 35, wherein the sealing material is indium or an alloy which contains indium.

48. The image display device according to claim 35, wherein the sealing material is an electrically nonconductive material.

49. The image display device according to claim 35, wherein the sealing material is fritted glass, an organic bonding material, or an inorganic bonding material.

50. The image display device according to claim 35, wherein the frame body has electrical conductivity.

51. The image display device according to claim 35, which comprises a phosphor layer provided on the inner surface of the front substrate and a plurality of electron sources which are provided on the inner surface of the rear substrate and excite the phosphor layer, and wherein the envelope is internally kept in a vacuum.

52. A method of manufacturing an image display device, which comprises an envelope having a front substrate and a rear substrate opposed to each other and a sealing portion which seals respective peripheral edge portions of the front substrate and the rear substrate together, the method comprising:
forming a sealing material layer on at least one of peripheral edge portions of the respective inner surfaces of the front substrate and the rear substrate so as to cover the whole circumference;
arranging the front substrate and the rear substrate, having the sealing material layer thereon, opposite to each other;
arranging a frame body, which extends along the respective peripheral edge portions of the front substrate and the rear substrate, between the peripheral edge portions of the respective inner surfaces of the front substrate and the rear substrate, the frame body having a sectional shape such that a space between the outer surface of the frame body and the peripheral edge portion of the inner surface of at least one of the front substrate and the rear substrate varies in the width direction of the frame body,
heating the sealing material layer to melt or soften a sealing material, pressurizing the front substrate and the rear substrate toward each other, and sealing the respective peripheral edge portions of the front substrate and the rear substrate.

53. The method of manufacturing an image display device according to claim 52, wherein the front substrate and the rear substrate are heated to melt or soften the sealing material layer in a vacuum atmosphere.

54. The method of manufacturing an image display device according to claim 52, wherein the frame body is formed of an electrically conductive material, and the frame body is supplied with current to melt or soften the sealing material layer in a vacuum atmosphere.

55. The method of manufacturing an image display device according to claim 52, wherein the sealing material layer is formed of an electrically conductive material, and the sealing material layer is supplied with current to be melted or softened in a vacuum atmosphere.
